(19) United States
(12) Patent Application Publication
(10) Pub. No.: US 2026/0289951 A1
(43) Pub. Date: Sep. 24, 2026

(54) SYSTEM

(71) Applicant: SoftBank Group Corp., Tokyo (JP)

(72) Inventor: Kazuya HIRABAYASHI, Tokyo (JP)

(73) Assignee: SoftBank Group Corp., Tokyo (JP)

(21) Appl. No.: 19/555,952

(22) Filed: Mar. 4, 2026

(30) Foreign Application Priority Data
Mar. 19, 2025 (JP) 2025-044499

(51) Int. Cl. G06V 10/44; G06N 3/0464; G06T 17/00; G06V 10/56; G06V 10/74

(52) U.S. Cl. CPC G06V 10/44; G06N 3/0464; G06T 17/00; G06V 10/56; G06V 10/761

(57) ABSTRACT

A system includes a processor that is configured to acquire an image of clothing held by a user, analyze the acquired image to extract features of the clothing including at least a color, a shape, and a pattern, and generate a prompt for instructing a generative AI model to perform similarity calculation based on the extracted features.

### CROSS-REFERENCE TO RELATED APPLICATION

This application is based on and claims priority under 35 USC 119 from Japanese Patent Application No. 2025-044499 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional fashion coordination support systems that utilize images of clothing owned by a user have several limitations. First, many existing systems merely perform image similarity search against a fixed database and do not leverage generative AI models in a structured manner. As a result, such systems are limited to retrieving existing coordination examples and cannot flexibly generate new proposals or decorations tailored to the user's clothing features. Second, when generative AI is used in a naive way, prompts are often manually created or statically defined, and are not automatically adapted based on the detailed visual features of the user's clothing. This leads to low relevance between the user's actual clothing items and the AI's output. Third, conventional systems typically do not sufficiently consider user-specified attributes and situations, such as age, gender, usage scene, or purpose, when generating prompts for a generative AI model. Consequently, the obtained suggestions may not match the user's context, resulting in low usability and user satisfaction. Furthermore, there is no adequate mechanism for automatically generating or adjusting prompts that both reflect extracted image features and incorporate user-specified conditions, thereby limiting the precision, personalization, and practicality of decoration and coordination proposals. Therefore, there is a need for a technique that automatically generates and adjusts prompts for a generative AI model, based on both visual features extracted from clothing images and user-specified conditions, to obtain highly relevant similarity calculations, decoration proposals, and decoration generation.

### SUMMARY

In order to solve the above-described problems, according to one aspect of the present invention, there is provided a system comprising a processor, wherein the processor is configured to acquire an image of clothing held by a user, analyze the acquired image to extract features of the clothing including at least a color, a shape, and a pattern, and generate a prompt for instructing a generative AI model to perform similarity calculation based on the extracted features. By extracting concrete visual features from the clothing image and embedding these features into the prompt, the system enables the generative AI model to perform similarity calculation in a manner that is accurately aligned with the actual characteristics of the user's clothing. According to another aspect of the present invention, the processor is configured to adjust the prompt in consideration of conditions including at least one of an attribute and a situation specified by the user, in order to instruct the generative AI model to propose decoration. In this way, the system modifies or augments the prompt by reflecting user context such as age, gender, and usage scene, thereby enabling the generative AI model to output decoration proposals suitable for the user's profile and intended situation. According to still another aspect of the present invention, the processor is configured to generate a prompt for instructing the generative AI model to generate decoration based on conditions specified by the user. Through this configuration, the system can directly obtain, from the generative AI model, new decoration content that is not merely retrieved from existing data but is generated on the basis of user-specified conditions. As a result, the system automatically and dynamically generates and adjusts prompts for the generative AI model, based on both the clothing image features and the user's conditions, thereby improving the relevance, personalization, and usefulness of similarity calculations, decoration proposals, and decoration generation.
The term “system” refers to an apparatus or a combination of hardware and software components that cooperate to execute processing defined in the present invention, and may be implemented by one or more physical devices, such as a server, a client device, or a distributed computing environment.
The term “processor” refers to any hardware component or logical processing unit that executes instructions, including but not limited to a CPU, GPU, DSP, ASIC, FPGA, microcontroller, or a combination thereof, and which is configured to perform the image analysis, feature extraction, and prompt generation described in the present invention.
The term “user” refers to a person who operates the system, provides images of clothing, and specifies attributes, situations, or other conditions used for generating or adjusting prompts for a generative AI model.
The term “clothing” refers to garments, apparel items, or fashion accessories worn on the body, including, for example, tops, bottoms, outerwear, dresses, shoes, and bags, which are subject to image acquisition and analysis in the present invention.
The term “image of clothing” refers to a digital image, such as a photograph or a frame of video, in which at least one item of clothing is depicted and which can be acquired and processed by the processor for feature extraction.
The term “acquire an image” refers to obtaining a digital image by any means, including capturing the image using a camera of a device, receiving the image from a storage medium, or downloading the image from a network resource, such that the processor can access the image data.
The term “analyze the acquired image” refers to processing the digital image data using image processing and/or machine learning techniques in order to detect and interpret visual properties relevant to the clothing depicted in the image.
The term “feature” refers to a piece of information representing a visual characteristic of the clothing in the image, including but not limited to color, shape, pattern, texture, silhouette, or structural attributes, which can be numerically or symbolically expressed and used for subsequent processing.
The term “color” refers to a visual attribute of the clothing corresponding to chromaticity and brightness, such as hue, saturation, and value, which may be represented in a color space (for example, RGB, HSV, or Lab) and used as part of the extracted features.
The term “shape” refers to the geometric form or outline of the clothing item, including, for example, overall silhouette, contour, length, and width characteristics, which can be represented by geometric descriptors or learned feature vectors.
The term “pattern” refers to a repetitive or structured visual configuration on the surface of the clothing, such as stripes, checks, polka dots, floral prints, logos, or other decorative motifs, which can be identified and encoded as part of the clothing features.
The term “generative AI model” refers to a machine learning model configured to generate outputs, such as text, images, or other content, based on input data or prompts, including but not limited to large language models, text-to-image models, or multimodal generative models.
The term “prompt” refers to information supplied to the generative AI model, typically in the form of text or structured data, which specifies instructions, conditions, or context for controlling the operation and output of the generative AI model.
The term “generate a prompt” refers to creating or composing a prompt by the processor, including specifying content that reflects extracted features, user attributes, situations, or other conditions, so that the generative AI model can be controlled in a desired manner.
The term “adjust the prompt” refers to modifying, supplementing, or re-structuring an existing prompt by the processor, in response to user-specified attributes, situations, or other conditions, so as to refine or change the instructions given to the generative AI model.
The term “similarity calculation” refers to processing performed by or under control of the generative AI model to determine a degree of similarity or relatedness between the clothing features contained in a prompt and other reference items, patterns, or concepts, resulting in a similarity score or ranking.
The term “decoration” refers to a proposed styling, coordination, or embellishment related to the clothing, including, for example, recommendations of additional items, accessories, color combinations, or outfit arrangements that enhance or complement the clothing.
The term “propose decoration” refers to having the generative AI model output suggestions, descriptions, or recommendations concerning how to style, coordinate, or adorn the clothing, based on the instructions contained in the prompt.
The term “generate decoration” refers to having the generative AI model produce one or more concrete decoration outputs, such as textual styling instructions, coordination plans, or other content, in response to a prompt that reflects user-specified conditions.
The term “attribute specified by the user” refers to a user-defined characteristic associated with the user or the intended use of the clothing, including but not limited to age group, gender, fashion preference, or personal taste.
The term “situation specified by the user” refers to a user-defined context or scene in which the clothing is intended to be worn, including but not limited to a date, office work, formal event, casual outing, or seasonal occasion.
The term “condition specified by the user” refers to any input constraint, preference, or requirement provided by the user, including attributes, situations, styles, seasons, colors, or other parameters, which are used by the processor to generate or adjust prompts for the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

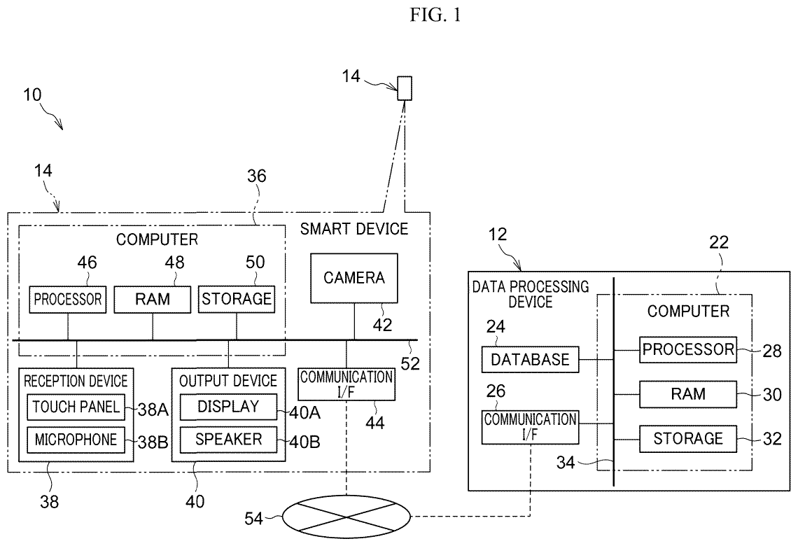

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

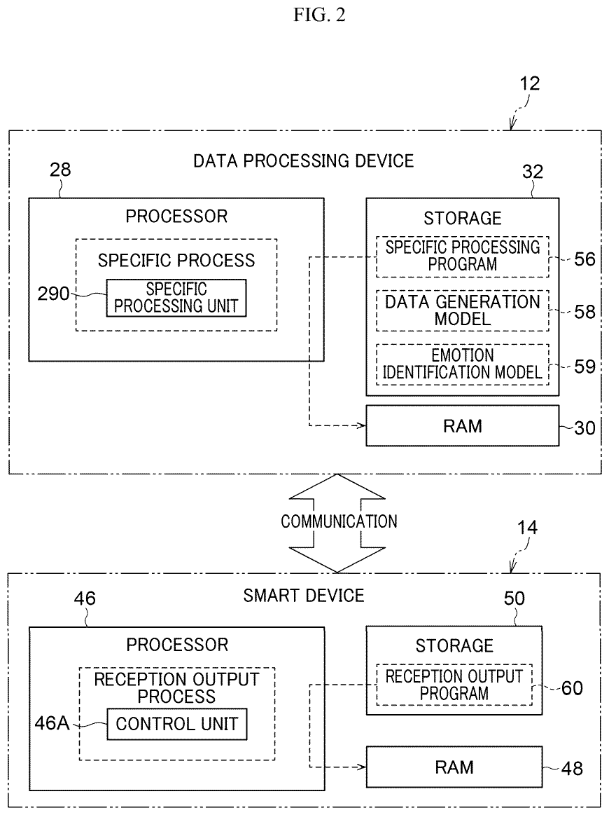

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional coordination and styling support systems typically rely on rule-based engines or simple retrieval mechanisms that match user-provided images or keywords to pre-authored outfits. Such systems suffer from several technical limitations. First, they often treat image analysis and text generation as isolated processes, without a unified flow of machine-readable context from computer vision models to natural language generation models. As a result, the system cannot fully exploit high-dimensional feature representations extracted from images, and the generated output is either generic or weakly aligned with the actual content of the user's article.
Second, existing systems generally perform similarity search directly on metadata or shallow tags and do not incorporate feedback from natural language generation models into the ranking or refinement of candidate proposals. This leads to inefficient use of computational resources because the system may retrieve and present proposals that are technically similar at the feature level but poorly described or not practically useful for the user's intended conditions. The absence of a feedback loop between similarity computation and generative output reduces the overall quality and relevance of the proposals.
Third, prompt sentences provided to generative AI models are often manually crafted or static, and do not systematically encode structured feature information, similarity ranking results, and user-specific usage conditions in a machine-generated, context-rich manner. This primitive prompt construction causes instability and inconsistency in the output of the generative models, forcing developers either to over-engineer prompts or to accept suboptimal natural language descriptions. The underlying computer system thus fails to efficiently coordinate image preprocessing, feature extraction, similarity search, prompt construction, and generative inference in an integrated pipeline.

Accordingly, there is a need for an improved computer-implemented system that automatically converts low-level image data of a user's article into structured feature information, uses that feature information to perform similarity-based retrieval of candidate proposals, and programmatically constructs context-rich prompt sentences for a generative AI model. There is also a need for a system that analyzes the content of generated natural language descriptions and uses that analysis, together with similarity scores, to reevaluate and reorder the candidate proposals. Such improvements would enhance the technical functioning of the overall system by increasing coherence between image-derived features and generated text, improving the efficiency and effectiveness of similarity-based retrieval, and stabilizing the behavior of the generative AI model through dynamically generated, context-aware prompts.

The specific processing by the specific processing unit 290 of the data processing device 12 in Example 1 is realized by the following means.

The present invention provides a server comprising a processor configured to obtain, via a terminal device, image data of an article possessed by a user and receive the image data through a communication procedure; to preprocess the image data by executing an image processing algorithm so as to convert the image data into an input format of a machine learning model and to extract feature information representing attributes of the article from the image data; to calculate, based on the extracted feature information, a similarity between the feature information and reference data stored in a storage device or an external information providing device as an information source, and to rank candidate proposal information according to the similarity; to convert context information including the feature information and the ranked candidate proposal information into text data, to generate a prompt sentence including the text data, and to generate request data for inputting the prompt sentence to a generative information processing model that performs natural language generation processing; to obtain natural language descriptions regarding the candidate proposal information, the natural language descriptions being output from the generative information processing model, and to associate the natural language descriptions with the candidate proposal information to generate proposal result data; and to analyze contents of a plurality of the natural language descriptions, reevaluate the candidate proposal information based on both a ranking result of the similarity and the contents of the natural language descriptions, and configure the proposal result data according to a ranking result after the reevaluation. This enables an integrated computer-implemented pipeline in which image-derived feature vectors are systematically linked to similarity-based retrieval and dynamically generated prompt sentences, thereby improving the technical quality and consistency of natural language outputs, increasing the relevance and ordering accuracy of candidate proposals, and enhancing overall system performance in generating contextually accurate, usage-condition-aware recommendations.
The term “system” refers to an aggregation of one or more hardware devices and software components that cooperate to execute the processing described in the claims, including at least a server and one or more terminal devices.
The term “processor” refers to a hardware-based information processing unit, such as a central processing unit or graphics processing unit, or a combination thereof, capable of executing instructions to perform the operations described in the claims.
The term “terminal device” refers to an information processing apparatus operated by a user, such as a mobile device, a portable computing device, or a stationary computing device, that can capture, store, and transmit image data and display received information.
The term “article” refers to a tangible object possessed, worn, or used by a user, including but not limited to clothing, accessories, or similar items, that can be represented in image data.
The term “image data” refers to digital data representing a visual image of an article, including data encoded in formats such as raster image formats or comparable encodings.
The term “communication procedure” refers to a sequence of operations performed according to a communication protocol, such as a network protocol, for transmitting and receiving data between the terminal device and the server.
The term “image processing algorithm” refers to a sequence of computational operations executed on image data to transform, normalize, resize, or otherwise process the image data, including operations for preparing the image data as input to a machine learning model.
The term “machine learning model” refers to a computational model obtained through a training process using data, the model being capable of performing inference such as classification, feature extraction, or prediction based on input data.
The term “feature information” refers to data representing attributes of an article included in image data, the data being expressed, for example, as numerical feature vectors, category labels, or other structured descriptors derived from the image.
The term “attribute” refers to a distinguishable property of an article, including but not limited to color, shape, pattern, size, material, category, or style.
The term “reference data” refers to data stored in a storage device or provided by an external information providing device, the data including feature information and metadata associated with articles or proposals used as a basis for similarity computation.
The term “storage device” refers to a hardware component or system that stores data persistently or semi-persistently, such as a non-volatile memory device, a magnetic disk device, a solid-state drive, or a network-accessible storage system.
The term “external information providing device” refers to an information processing apparatus or service separate from the server, accessible via a communication network, that provides reference data or related information.
The term “similarity” refers to a quantitative or qualitative measure representing a degree of resemblance or correlation between feature information of a user's article and reference data, computed using a similarity function or distance metric.
The term “candidate proposal information” refers to data representing one or more candidate items, combinations, or suggestions selected based on a similarity computation, prior to final selection or presentation to the user.
The term “context information” refers to structured or semi-structured data that provides background or situational information to a generative information processing model, including feature information, candidate proposal information, and optionally user-related conditions or preferences.
The term “text data” refers to data representing characters or strings in a machine-readable form, suitable for use as input to a natural language processing or generative model.
The term “prompt sentence” refers to text data including instructions, descriptions, or constraints provided as input to a generative information processing model to control or guide the content and style of generated output.
The term “request data” refers to structured data, including at least a prompt sentence and optionally additional control parameters, transmitted to a generative information processing model in order to request natural language generation.
The term “generative information processing model” refers to a machine learning model configured to generate natural language or other data based on input text, including models commonly referred to as generative AI models or large language models.
The term “natural language generation processing” refers to a computational process in which a generative information processing model outputs text expressed in a human language based on input data such as a prompt sentence.
The term “natural language description” refers to a segment of text generated or processed by the system that expresses information in a human-readable language, describing, for example, candidate proposal information.
The term “proposal result data” refers to data generated by the processor that associates candidate proposal information with corresponding natural language descriptions, and that is prepared for transmission to a terminal device.
The term “usage condition information” refers to information indicating constraints, preferences, contexts, or intended use scenarios specified by the user, such as occasions, styles, seasons, or other conditions relevant to the proposals.
The term “ranking result” refers to an ordered arrangement of candidate proposal information determined according to one or more criteria, such as similarity values or analysis of natural language descriptions.
The term “reevaluation” refers to a process in which previously ranked candidate proposal information is reassessed using additional information or criteria, resulting in an updated ranking result.

In one embodiment, a server, a terminal, and a communication network cooperate to implement the claimed system. The server includes at least one processor, a main memory, a non-volatile storage device, and a network interface. The processor may be a central processing unit, a graphics processing unit, or a combination thereof. The terminal is implemented by a portable computing device, a stationary computing device, or a mobile communication device, including a display unit, a user input unit, a camera, a main memory, a non-volatile storage device, and a network interface.

The terminal executes an application program that controls hardware resources of the terminal. The terminal uses a camera function, such as a camera framework comparable to those provided in common mobile operating systems, to capture image data of an article possessed by a user. Alternatively, the terminal accesses a photo library application, such as a gallery function provided by the operating system, to obtain existing image data. The terminal encodes the captured or selected image as a digital file in a raster image format such as JPEG or PNG and stores the file in a file system of the terminal.

The terminal uses an image processing library, such as a library comparable to OpenCV, to preprocess the image data. The terminal resizes the image to a predetermined resolution, performs color space conversion to a predetermined color space, and applies normalization to pixel values. The terminal may remove unnecessary metadata from the image header to reduce data size. The terminal packs the processed image data into a request message in accordance with a hypertext transfer protocol and transmits the request message to the server through the network interface.

The server receives the request message through the network interface and temporarily stores the image data in a storage device, such as a solid-state drive or a non-volatile memory device. The server loads the image data into a main memory and applies an image preprocessing procedure using an image processing library. The server resizes and normalizes the image data into a tensor representation suitable for input to a machine learning model. The tensor is arranged in a predetermined data structure, such as a multi-dimensional array with dimensions corresponding to batch size, color channel, and spatial resolution.

The server uses a machine learning framework, such as a framework comparable to TensorFlow or PyTorch, to execute a trained neural network model. The server loads a model file from the storage device into the main memory. The model has been trained prior to deployment using a large number of training images of various articles and associated labels.

The server configures the model in inference mode and deploys the model to an accelerator, such as a graphics processing unit, to execute matrix multiplication and convolution operations efficiently.

The server uses a convolutional neural network architecture that includes multiple convolution layers, non-linear activation layers, pooling layers, and fully connected layers.

The server arranges the model so that an intermediate layer outputs a feature vector representing high-level attributes of the article. During training, the server has used a supervised learning method with a loss function such as cross-entropy loss or metric-learning loss, and has updated model weights by a gradient-based optimization algorithm such as stochastic gradient descent with momentum or an adaptive learning method. The server has optionally performed data augmentation, such as random cropping, rotation, and color jitter, to improve robustness of the feature representation.

During inference, the server passes the preprocessed tensor through the convolutional neural network. The server obtains, from a designated intermediate layer, a feature vector, for example a vector of several hundred to several thousand floating-point elements. The server may also obtain classification scores for predefined categories, such as item types or style labels. The server converts the feature vector into a normalized representation by applying operations such as L2 normalization. The server further derives structured feature information by mapping the feature vector and classification scores to attributes such as color, shape, pattern, and style. The feature information is stored as a data structure including numerical vectors and symbolic tags.

The server maintains reference data in a storage device or accesses reference data from an external information providing device over the network. The reference data include feature vectors precomputed for a large number of reference articles or reference proposals and also include metadata describing these references. The server organizes the reference feature vectors in an index structure suitable for similarity search, such as an approximate nearest neighbor index. The server uses a distance function, such as cosine distance or Euclidean distance, to compute similarity between the feature information of the user's article and the reference feature vectors.

The server computes similarity values by applying vector operations between the feature vector of the user's article and the reference feature vectors. The server extracts, from the index structure, a set of candidates having the highest similarity values. The server constructs candidate proposal information from the retrieved reference data. The candidate proposal information includes identifiers of the references, associated images, metadata, and the similarity values. The server ranks the candidate proposal information in descending order of similarity and stores the ranked list in a memory.

The server constructs context information to be provided to a generative AI model as input.

The server generates text fragments describing the extracted attributes of the user's article, such as “red skirt,” “knee-length,” “lightweight fabric,” and similar descriptors. The server generates additional text fragments summarizing characteristics of the top-ranked candidates, such as typical pairings, color combinations, and usage contexts. The server optionally incorporates usage condition information that the user has input through the terminal, for example, “office appropriate,” “casual weekend,” or “avoid high heels.”

The server concatenates these text fragments into a coherent prompt sentence. The server may adopt a template in which placeholders are replaced by dynamic content generated from the feature information, the candidate proposal information, and the usage condition information. For example, the server may construct a prompt sentence as follows:
“User's clothing item: a red, knee-length skirt made of lightweight fabric, suitable for casual to semi-formal occasions. Similar looks from the database include outfits with white blouses, black turtlenecks, and striped tops, combined with neutral shoes and simple accessories. Based on this information, as a fashion stylist, propose 5 practical outfit coordinations that match this red skirt. For each coordination, specify: (1) the top (color, style, material), (2) suitable shoes, (3) optional accessories, and (4) a brief style description (e.g., casual, office, date). Keep each suggestion in 2-3 concise English sentences.”

The server uses such a prompt sentence as request data for a generative AI model. The generative AI model is implemented by a neural network configured for natural language generation, such as a transformer-based language model. The server accesses the model either as a locally deployed model or as a network service. When the model is locally deployed, the server stores model parameters in the storage device and loads them into memory. The transformer architecture includes multiple self-attention layers, feedforward layers, and normalization layers. The model has been trained on a large corpus of text using an unsupervised or semi-supervised learning method, with an objective such as next-token prediction or masked-token prediction, using a loss function like cross-entropy and an optimization algorithm similar to those used for the convolutional network.

The server tokenizes the prompt sentence into subword units according to a tokenizer associated with the generative model, converts tokens into embedding vectors, and feeds the sequence of embeddings into the model. The model computes hidden representations at each layer using self-attention mechanisms. The server controls generation parameters, such as temperature, top-k, or top-p thresholds, to influence diversity and determinism of the output. The model outputs, step by step, tokens constituting natural language descriptions of the candidate proposals.

The server receives the generated tokens and decodes them into text strings representing natural language descriptions. The server parses the descriptions to separate different proposals, using delimiters or patterns specified in the prompt. The server associates each description with one or more items in the candidate proposal information. For example, if a description refers to a “white blouse,” the server correlates this phrase with candidate entries labeled as white tops in the reference data.

The server optionally analyzes the generated descriptions in more detail. The server may tokenize each description, extract keyword features, and compute a textual relevance score based on comparison with user-specified conditions or with structured attributes of the candidate items. The server combines the similarity ranking result derived from feature vectors with the textual analysis result to reevaluate the candidate proposal information. The server assigns a revised score to each candidate based on a weighted combination of the visual similarity score and the textual relevance score, and then reorders the candidate list accordingly.

The server constructs proposal result data that includes the reevaluated candidate proposal information, the corresponding natural language descriptions, and additional metadata such as identifiers and references to image files. The server serializes the proposal result data into a structured format and transmits the data to the terminal via the network interface.

The terminal receives the proposal result data, parses the structured format using a data parsing library, and generates internal data structures for display. The terminal loads thumbnail images or other graphical representations of the recommended items, arranges them on the display in accordance with the ranking order, and displays the associated natural language descriptions. The terminal may display, for each proposal, the summary of the outfit, component items, and a brief textual explanation as generated by the generative AI model. The user can interact with the display, select specific proposals, and request further refinements.

The server may generate additional prompt sentences for refinement based on user feedback. When the user modifies conditions through the terminal, the server incorporates the new usage condition information into the context information and regenerates a prompt sentence. For example, the server may construct a refinement prompt sentence such as:
“Refine the previous outfit suggestions for a red, knee-length skirt so that all outfits are suitable for an office environment and do not use high heels. Propose 3 new coordinations with tops, shoes, and accessories, and briefly explain why each outfit is appropriate for the office.”

The server then repeats the natural language generation and reevaluation process to provide updated proposals.

In this system, the server does more than simply automate a manual styling process. The server introduces a specific data flow and data structures that directly improve computer operation. By transforming raw image data into compact feature vectors using a trained convolutional neural network, the server reduces the dimensionality of the data while preserving semantic attributes, thereby reducing storage requirements and improving retrieval speed. The similarity search using the feature index enables logarithmic or sub-linear search performance compared to linear scanning of raw data, thus improving processing speed as the number of reference items increases.

Further, the server improves accuracy and stability of the generative AI model by constructing prompt sentences programmatically from structured context information. Because the prompt sentences encode numerical similarity results, categorical tags, and user conditions in a consistent format, the variance of the generative model output is reduced and alignment with the underlying image content is improved. This constitutes an improvement in how the computer system interacts with a generative model, resulting in lower rates of incoherent or irrelevant outputs.

The reevaluation process that combines similarity rankings and textual analysis also improves the technical performance of the system. Instead of presenting the raw similarity results, the server refines the order based on semantic content obtained from the generative model. This dual-stage evaluation uses vector operations and text similarity computations that are difficult to perform manually and that take advantage of the computer's ability to process large volumes of structured and unstructured data. As a result, the system can decrease the average number of iterations required for the user to find a satisfactory proposal, thereby reducing network traffic and processing load.

The server's use of neural network models trained with specific loss functions and optimization algorithms, together with a carefully designed integration of feature extraction, similarity indexing, and prompt generation, leads to improvements in computation efficiency and precision. Because the system leverages compact feature vectors and optimized approximate nearest neighbor search, the server can respond in real time even when the reference database contains a large number of items. The server's dynamic prompt construction and reevaluation logic are not simple business rules, but computer-implemented algorithms that manipulate numerical and symbolic representations in a non-conventional order and structure, thus enhancing the internal operation of the computer system itself.

Alternative embodiments may use different neural network architectures, such as residual networks, vision transformers, or hybrid models combining convolutional layers with attention layers for feature extraction. The server may employ different similarity measures, such as learned metric embeddings or probabilistic similarity scores. The generative AI model may be replaced by a different sequence-to-sequence architecture or an encoder-decoder model, provided that the server can supply context in the form of a prompt sentence and receive natural language descriptions in return. The prompt construction template may be varied to include more detailed constraints, such as budget ranges, seasonality, or dress codes, and the reevaluation algorithm may incorporate additional computational methods, such as reinforcement learning-based ranking or multi-objective optimization.

In all such embodiments, the server, the terminal, and the described data processing methods cooperate to realize a system in which high-dimensional image information is converted to structured features, efficiently matched to reference data, and translated into context-aware natural language recommendations through a generative AI model, thereby improving the functional performance of the computer system beyond a mere automation of human judgment.

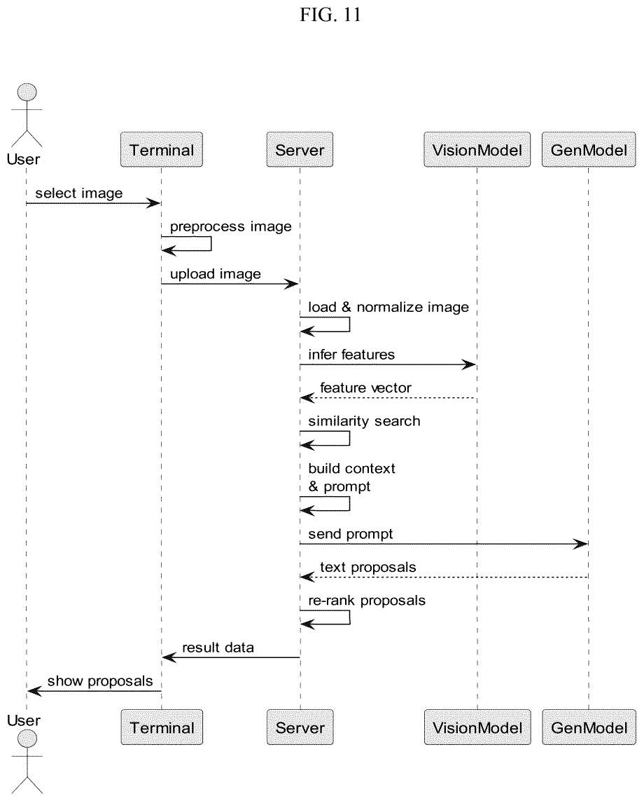

The following describes the processing flow using FIG. 11.

### Step 1:

The user operates the terminal to provide an image of an article. The user activates a camera application or a gallery application on the terminal and either captures a new image or selects an existing image file. The input is a real-world article visually presented to the camera or an already stored digital image. The terminal receives the image as raw pixel data or as a file in a raster image format such as JPEG or PNG. The terminal stores this file in a local file system and outputs a file reference and the binary image data for further processing.

### Step 2:

The terminal preprocesses the acquired image data before transmission. The input is the stored image file and its binary data. The terminal uses an image processing library to resize the image to a fixed resolution, normalize the pixel values, and optionally convert the color space to a standardized format. The terminal may also strip metadata to reduce data size and protect privacy. The terminal outputs a preprocessed image buffer and constructs an HTTP or HTTPS request containing the preprocessed image as a payload, along with user identification data and session information.

### Step 3:

The terminal transmits the preprocessed image data to the server. The input is the HTTP or HTTPS request that encapsulates the preprocessed image buffer and related headers. The terminal sends the request through a communication network using a network interface. The server receives the request, extracts the image payload, verifies the integrity and format of the data, and stores the image temporarily in a storage device. The output of this step on the server side is a valid image file stored with an associated record containing metadata such as user identifier and timestamp.

### Step 4:

The server performs image preprocessing and tensor conversion for machine learning input. The input is the stored image file and its metadata. The server loads the image into main memory, decodes it into pixel arrays, and applies additional preprocessing such as center-cropping and normalization to match the expected input distribution of a neural network. The server then converts the processed pixel arrays into a multi-dimensional tensor with dimensions corresponding to batch, channel, height, and width. The output is a normalized tensor ready to be fed into a machine learning model.

### Step 5:

The server executes a feature extraction model on the image tensor. The input is the normalized image tensor and a trained convolutional neural network model loaded into memory. The server performs a forward pass through multiple convolutional, activation, pooling, and fully connected layers, computing intermediate feature maps and final activations. The server extracts a high-dimensional feature vector from a designated intermediate layer and may also obtain classification logits for predefined labels. The output is structured feature information, including a numerical feature vector and associated attribute tags such as color, shape, and pattern.

### Step 6:

The server retrieves and prepares reference data for similarity comparison. The input is the feature vector of the user's article and a reference index stored in a storage device or available through an external information source. The server queries the index, which contains precomputed feature vectors and metadata for reference items or proposals. The server may load a subset of reference vectors into memory and organize them for efficient distance calculation. The output is a collection of reference feature vectors and associated metadata that will be compared with the user's feature vector.

### Step 7:

The server computes similarity between the user's feature vector and reference feature vectors. The input is the user's feature vector and the set of reference feature vectors. The server applies a similarity function, such as cosine similarity or Euclidean distance, by performing vector arithmetic operations for each pair of vectors. The server calculates similarity scores for each reference and sorts the references according to these scores. The output is a ranked list of candidate proposal information, each entry including a reference identifier, similarity score, and associated metadata.

### Step 8:

The server constructs context information from the feature data and ranked candidates. The input is the user's attribute tags, the numerical feature information, and the ranked list of candidate proposal information. The server selects top-ranked candidates and aggregates their metadata, such as dominant colors, item types, and typical pairings. The server may also receive usage condition information from the terminal, such as preferred style or occasion, and merge this with the feature-based context. The output is a structured context object containing attributes of the user's article, summaries of candidate proposals, similarity values, and usage conditions.

### Step 9:

The server generates a prompt sentence for the generative AI model. The input is the structured context object with feature attributes, candidate summaries, and usage conditions. The server applies a text template or rule-based composition logic to convert the context into natural language fragments and concatenates them into a coherent prompt sentence. The server may insert explicit instructions, such as the number of proposals to generate and required output fields. The output is a complete prompt sentence that describes the user's article, the reference context, and the desired format of the generative output.

### Step 10:

The server submits the prompt sentence to a generative AI model and obtains natural language descriptions. The input is the constructed prompt sentence and configuration parameters for the language generation process, such as maximum length and temperature. The server tokenizes the prompt, transmits the token sequence or text to a generative model, and initiates an inference process that sequentially predicts output tokens. The server receives the sequence of generated tokens, decodes them into text, and segments the text into multiple descriptions corresponding to different proposals. The output is a set of natural language descriptions that explain and detail the candidate proposals.

### Step 11:

The server analyzes and associates the generated descriptions with candidate proposal information. The input is the ranked candidate proposal list and the set of natural language descriptions. The server parses each description, identifies references to specific attributes or items, and aligns these references with candidate metadata, for example by keyword matching or tag comparison. The server then attaches each description to one or more candidate proposals, forming pairs of structured item data and explanatory text. The output is intermediate proposal result data in which each candidate proposal is linked with at least one natural language description.

### Step 12:

The server reevaluates and reorders the candidate proposals based on similarity scores and description content. The input is the intermediate proposal result data including similarity scores and textual descriptions. The server computes additional textual relevance scores by analyzing the descriptions against user conditions and structured attributes, for example counting matched keywords or computing semantic similarity. The server combines the original similarity score with the textual relevance score using a weighted formula and produces a revised overall score. The server sorts the proposals by this revised score. The output is a finalized set of proposal result data with updated ranking and associated descriptions.

### Step 13:

The server transmits the finalized proposal result data to the terminal. The input is the finalized set of proposal result data, including candidate identifiers, images or image references, updated ranking, and natural language descriptions. The server serializes this data into a structured message and sends the message to the terminal via the network interface using a communication protocol. The output on the server side is a transmitted response, and on the terminal side the output is a received data structure that contains all information necessary for display.

### Step 14:

The terminal parses the proposal result data and prepares display content. The input is the structured response received from the server. The terminal uses a parsing library to convert the structured data into internal objects representing each proposal. The terminal loads or requests thumbnail images according to item identifiers or image URLs, associates these with the textual descriptions and scores, and arranges them into a display layout such as a list or grid. The output is a set of rendered user interface components that represent each proposal ready to be shown on the display unit.

### Step 15:

The user reviews the displayed proposals and provides feedback or additional conditions. The input is the rendered list of proposals, each with an image and a natural language description. The user may select a preferred proposal, request more similar proposals, or input refinements such as desired occasion or style constraints. The terminal captures this feedback through the user input unit, converts it into structured condition data, and prepares a new request to the server. The output is updated usage condition information and interaction data that can be used by the server to refine or regenerate proposals.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional outfit recommendation and virtual try-on systems suffer from several technical shortcomings when implemented on general-purpose computing devices. First, many systems treat a user's clothing image merely as a label input (for example, “red sweater”) and do not compute or exploit a structured, machine-interpretable feature representation. As a result, similarity retrieval against large-scale image collections is inaccurate or computationally inefficient, thereby degrading the overall performance of the system. Second, known systems often rely on static, rule-based recommendation logic and do not generate or refine machine-readable instructions for a generative model based on low-level image features and retrieved examples. This leads to limited personalization and requires substantial manual tuning of prompts and parameters.

Third, existing virtual try-on mechanisms typically do not tightly couple the text-level outfit proposals with three-dimensional model generation and adaptation. In many cases, three-dimensional assets are manually selected or pre-mapped to coarse categories, and the computing system must perform multiple ad hoc conversions between text, image, and three-dimensional data. This fragmented processing pipeline causes redundant computation, inefficient use of memory and network resources, and reduced responsiveness on user-side terminals, particularly when rendering complex scenes or multiple outfit variations.

Furthermore, feedback from the user, such as explicit ratings or implicit interaction patterns, is rarely integrated back into the computational chain that generates the prompts and adjusts the similarity calculations. Without such integration, the processor cannot adaptively learn user preferences at a system level, and thus cannot improve the efficiency and relevance of subsequent inferences and data retrieval operations.

Accordingly, there is a need for a computer-implemented technique that (i) extracts structured feature information from user-owned clothing images, (ii) performs similarity computation against large-scale outfit image data in a computationally efficient manner, (iii) programmatically constructs and adjusts prompt sentences for a generative model based on both feature data and retrieved examples, (iv) automatically associates generated outfit proposals with three-dimensional clothing models adapted to user-specific body shape data, and (v) updates prompt generation and similarity parameters based on user evaluation information. Such a technique would improve the functioning of the underlying computers by optimizing data flows between image analysis, generative modeling, similarity search, and three-dimensional rendering, thereby enabling faster, more accurate, and more adaptive outfit generation and virtual try-on simulations.

The specific processing by the specific processing unit 290 of the data processing device 12 in Application Example 1 is realized by the following means.

The present invention provides a server comprising a processor, the processor being configured to acquire, from an information processing terminal operated by a user, image data corresponding to clothing possessed by the user; to analyze the image data by executing image recognition processing to extract feature information, including at least color, shape, pattern, material, and category of the clothing, and to generate a numerical vector representing the feature information; to calculate similarity, by using the numerical vector, with respect to a group of outfit image data acquired from an information providing service in which outfit image data is stored, and to extract outfit image data having high similarity from the group of outfit image data; to generate a prompt sentence including an instruction to a generative model to generate outfit candidates using the clothing, based on the feature information and the outfit image data having high similarity; to input the prompt sentence into the generative model to obtain outfit proposal information including a plurality of outfit proposals each including the clothing; to assign three-dimensional shape data to clothing elements included in the outfit proposal information and to generate three-dimensional clothing models adapted to body shape data associated with the user; to transmit the three-dimensional clothing models to the information processing terminal and to output display control information enabling execution of a try-on simulation of the clothing in a virtual space on the information processing terminal; and, in some embodiments, to acquire condition information including at least preference information, usage scene information, season information, body shape information, and budget information input by the user, and to adjust the prompt sentence by changing instruction content to the generative model based on a combination of the condition information, the feature information, and the outfit image data having high similarity; and, in some embodiments, to acquire evaluation information from the user regarding the outfit proposal information and to update components of the prompt sentence and parameters used for the similarity calculation based on the evaluation information so as to sequentially and adaptively change instruction content to the generative model to generate outfit proposal information optimized for each user. This enables the computing system to improve internal data representations and control flows for outfit generation and virtual try-on, thereby enhancing the efficiency and accuracy of similarity computation, reducing redundant processing between image analysis, generative inference, and three-dimensional rendering, and adaptively optimizing future prompt sentences and similarity parameters based on user feedback, which in turn improves the overall performance of the computer-implemented outfit recommendation and simulation process.

The term “system” refers to a collection of one or more computing devices, storage devices, communication interfaces, and software components that cooperate to perform the functions described in the claims.
The term “processor” refers to one or more hardware processing units, such as a central processing unit, a graphics processing unit, a digital signal processor, or any combination thereof, configured to execute instructions and perform arithmetic and logical operations.
The term “information processing terminal” refers to any user-operated computing device, such as a smartphone, tablet, wearable device, head-mounted display, or personal computer, that can capture, transmit, receive, and display digital data.
The term “user” refers to a human operator who interacts with the information processing terminal and the system to provide inputs and receive outputs related to clothing and outfit proposals.
The term “image data” refers to digital data representing at least one image, such as a still picture or frame, encoded in a format interpretable by the processor, including but not limited to bitmap or compressed image formats.
The term “clothing” refers to any wearable article, including garments, footwear, accessories, or similar items intended to be worn on a human body.
The term “feature information” refers to structured data that describes characteristics of the clothing extracted from the image data, including but not limited to color, shape, pattern, material, and category.
The term “color” refers to a visual attribute of the clothing represented as one or more values in a color space, such as red, green, and blue components, hue, saturation, and brightness, or any equivalent representation.
The term “shape” refers to the geometric outline, contour, or structural form of the clothing as derived from the image data or three-dimensional data.
The term “pattern” refers to repetitive or distinctive visual elements on the clothing, such as stripes, checks, prints, or textures, identifiable from the image data.
The term “material” refers to a physical or visual substance of the clothing, such as fabric type, surface texture, or other properties inferred from the image data.
The term “category” refers to a classification of the clothing into a type or class, such as top, bottom, outerwear, footwear, or accessory, as determined by the processor.
The term “numerical vector” refers to an ordered set of numerical values representing the feature information of the clothing in a machine-interpretable form suitable for similarity computation or input to a model.
The term “similarity” refers to a quantitative measure of resemblance between two sets of feature information or numerical vectors, computed by the processor according to a predefined similarity function.
The term “outfit image data” refers to image data representing one or more coordinated combinations of clothing items, including associated metadata when available.
The term “information providing service” refers to any network-accessible service, platform, or data source in which outfit image data is stored and from which such data can be acquired by the processor.
The term “group of outfit image data” refers to a plurality of outfit image data items collected or obtained from the information providing service.
The term “outfit image data having high similarity” refers to outfit image data selected by the processor from the group of outfit image data based on the similarity measure exceeding a threshold or ranking within a predefined range.
The term “prompt sentence” refers to text data, which may include instructions, constraints, examples, and format specifications, that is provided as input to a generative model to guide generation of an output.
The term “generative model” refers to a machine learning model configured to produce output data, such as text or other structured information, in response to input data including a prompt sentence.
The term “outfit candidate” refers to a proposed combination of multiple clothing items, including at least the user's clothing, as generated or to be generated by the generative model.
The term “outfit proposal information” refers to data describing one or more outfit candidates, including at least constituent clothing elements, colors, styles, or other attributes produced by the generative model.
The term “clothing element” refers to an individual clothing item or component included in an outfit proposal, such as a top, bottom, outerwear, footwear, or accessory.
The term “three-dimensional shape data” refers to data representing a three-dimensional form, including at least vertex positions, edges, surfaces, or equivalent geometrical constructs suitable for three-dimensional rendering or simulation.
The term “three-dimensional clothing model” refers to a three-dimensional representation of a clothing element, defined by three-dimensional shape data and optionally including material, texture, or animation information.
The term “body shape data” refers to data representing a human body form associated with the user, including at least body measurements, proportions, or an avatar model, used to adapt three-dimensional clothing models.
The term “virtual space” refers to a computer-generated environment in which three-dimensional objects, including three-dimensional clothing models and body models, can be displayed and manipulated.
The term “display control information” refers to control data transmitted from the server to the information processing terminal that defines how three-dimensional clothing models and related elements are rendered, arranged, or animated in the virtual space.
The term “try-on simulation” refers to a process in which three-dimensional clothing models are virtually applied to a representation of the user's body shape in the virtual space to visually simulate wearing the clothing.
The term “condition information” refers to data specifying user-related or context-related constraints, including at least preference information, usage scene information, season information, body shape information, and budget information.
The term “preference information” refers to data indicating style, color, fit, or other fashion-related preferences of the user.
The term “usage scene information” refers to data describing intended usage situations for the clothing, such as work, leisure, formal events, or sports.
The term “season information” refers to data indicating a time-of-year or environmental condition, such as spring, summer, autumn, winter, or climate conditions, relevant to outfit selection.
The term “budget information” refers to data indicating monetary constraints or price ranges preferred or specified by the user for clothing items.
The term “evaluation information” refers to feedback data provided by the user regarding outfit proposal information, including explicit ratings, selections, rejections, or implicit interaction metrics.
The term “parameters used for the similarity calculation” refers to numerical or structural settings, such as weighting factors, distance metrics, thresholds, or normalization schemes, controlling how similarity between feature representations is computed.
The term “instruction content to the generative model” refers to the portion of the prompt sentence that specifies tasks, constraints, or desired characteristics for the output of the generative model.
The term “optimized for each user” refers to a state in which the outfit proposal information generated by the system is adapted to user-specific preferences, conditions, and evaluation information to provide improved relevance and suitability.

In one embodiment, the server cooperates with the terminal and the user to implement the claimed system by executing dedicated software modules on general-purpose hardware.

The server includes at least one processor, a volatile memory, a non-volatile storage device, and a network interface. The server executes an operating system and application software including a web service module, an image analysis module, a similarity search module, a prompt generation module, a generative AI interface module, a three-dimensional model generation module, and a user preference management module. The server is connected via a communication network to at least one terminal operated by the user.

The terminal includes at least one processor, a volatile memory, a non-volatile storage device, a camera device, a display device, and a network interface. The terminal executes an operating system and an application program associated with the system. The terminal may be implemented as a smartphone, a tablet, or a head-mounted display such as smart glasses. The terminal uses a camera framework, such as a camera library provided by a mobile operating system, to capture clothing images, and uses a graphics framework, such as a three-dimensional rendering engine or an augmented reality framework, to display three-dimensional clothing models in a virtual space.

The user operates the terminal to capture images of clothing items and to interact with outfit proposal information and try-on simulations. The user may explicitly provide condition information such as preferences, usage scenes, seasons, and budget through graphical user interface components of the application program.

The server acquires clothing image data from the terminal and stores the image data in a structured data repository. The server then performs image recognition processing using a trained neural network implemented in a machine learning framework such as a general-purpose tensor computation library. In one embodiment, the server uses a convolutional neural network (CNN) including multiple convolution layers, pooling layers, and fully connected layers, such as a residual network architecture. The server configures the CNN as follows: the input layer receives an image tensor normalized to a predetermined size and color space; intermediate layers apply convolution with learnable kernels and non-linear activation functions, such as rectified linear units; pooling layers reduce spatial resolution; and a final embedding layer outputs a numerical vector of fixed dimension, such as 512 or 1024 elements, representing the clothing's feature information.

The server trains the CNN in advance using a supervised learning procedure. The server prepares a training dataset of clothing images annotated with labels corresponding to color, shape, pattern, material, and category. The server defines a composite loss function including a classification loss term, such as cross-entropy, for predicting the labels, and a metric learning loss term, such as a triplet loss or contrastive loss, for encouraging images with similar attributes to have closer numerical vectors. The server performs gradient-based optimization, such as stochastic gradient descent or an adaptive gradient method, to update the network weights. During training, the server performs data augmentation operations on input images, including random cropping, horizontal flipping, color jittering, and scaling, to improve generalization. As a result of this training process, the server configures the CNN to output numerical vectors that capture a high-dimensional representation of clothing features suitable for similarity computation.

The server, during inference in actual operation, loads the trained CNN model into memory and applies it to the clothing image data acquired from the terminal. The server thereby generates feature information represented as a numerical vector and also derives auxiliary attributes such as color, shape, pattern, material, and category by reading the outputs of classification heads attached to the CNN.

The server stores the numerical vector in a feature index implemented as a vector database or an in-memory index structure. The server shapes the index as a set of high-dimensional points and uses an approximate nearest neighbor algorithm, such as a hierarchical navigable small world graph or a quantization-based index, to support efficient similarity search among large numbers of outfit image data records. The server acquires outfit image data from at least one information providing service and precomputes numerical vectors for those outfit images using the same CNN. The server registers the numerical vectors corresponding to the outfit images into the feature index.

The server calculates similarity between the numerical vector corresponding to the user's clothing and numerical vectors corresponding to the outfit images using a similarity function, such as cosine similarity or Euclidean distance. The server retrieves a subset of outfit image data having high similarity by selecting a predetermined number of nearest neighbors or by applying a threshold on the similarity score. This use of a learned embedding space and a dedicated similarity index improves computational efficiency compared to naive comparisons in raw pixel space and reduces latency when handling large image datasets.

The server generates a prompt sentence for a generative AI model based on both the feature information extracted from the user's clothing image and the outfit image data having high similarity. The server structures the prompt sentence as a natural language instruction to the generative AI model. The server composes multiple segments within the prompt sentence, including: (i) a description of the user's clothing item derived from the feature information, incorporating attributes such as color, pattern, and style; (ii) a summary of retrieved outfit examples constructed from metadata associated with the similar outfit image data; and (iii) explicit instructions regarding the number of outfit candidates to generate, the level of detail required, and any output formatting constraints.

In one example, the server generates a prompt sentence as follows:
“User clothing item: red cable-knit wool sweater, slightly oversized, crew neck, casual winter style. The user prefers simple and comfortable urban outfits. From our outfit database, we found these example looks:
1) Red sweater with dark blue skinny jeans and white sneakers (casual street style).
2) Red sweater with black pleated skirt and black ankle boots (chic casual).
3) Red sweater with light blue mom jeans and white high-top sneakers (relaxed).

Please act as a fashion stylist. Propose 5 new coordinated outfits that use this red sweater as the main item. For each outfit, specify: outfit name, detailed items (tops, bottoms, shoes, and accessories), main colors, and a short style explanation.”

The server, in another example, generates a prompt sentence as follows:
“Given a user-owned red cable-knit sweater for everyday winter wear, propose multiple outfit combinations that resemble popular looks in social image collections. Use styling similar to casual street fashion and combine the red sweater with jeans, skirts, shoes, and bags. Describe each outfit in full sentences, including the overall style image and how the colors balance.”

The server, by programmatically generating these prompt sentences from structured feature information and retrieved examples, differs from simple manual prompt entry and constrains the generative AI model to operate within a high-quality context space derived from machine-interpretable features. This structured prompt generation improves the consistency and relevance of model outputs and reduces the computational overhead associated with trial-and-error prompt tuning.

The server inputs the prompt sentence to a generative AI model, such as a large language model implemented as a transformer network with multiple self-attention layers. The server configures the generative AI model to receive tokenized text input and to output token sequences representing outfit proposal information. The server sets parameters such as maximum output length and sampling temperature to control diversity and determinism. The server may deploy the generative AI model on a separate inference server and communicate via an application programming interface.

The server parses the textual output of the generative AI model into structured outfit proposal information. The server identifies clothing elements, such as tops, bottoms, footwear, and accessories, and associated attributes such as color, style descriptor, and positioning. The server thereby creates structured data records describing each outfit candidate. The server stores these records in a database associated with the user.

The server also acquires condition information from the user. The user uses the terminal to input preference information, usage scene information, season information, body shape information, and budget information through interactive forms. The server associates these data items with the corresponding user profile. The server incorporates the condition information into subsequent prompt sentences by including explicit statements of preferences and constraints, such as desired formality, avoidance of certain colors, or a maximum price level. By integrating structured feature information, similarity-based examples, and condition information into the prompt sentence, the server allows the generative AI model to generate outfit proposals that are tailored to the user's context and preferences.

The server generates three-dimensional clothing models corresponding to the clothing elements contained in the outfit proposal information. The server maintains a library of three-dimensional shape data assets representing generic items such as sweaters, shirts, trousers, skirts, and shoes. Each asset includes mesh geometry, material definitions, and texture maps. The server, upon receiving an outfit proposal, selects one or more base three-dimensional assets whose categories and basic shapes match the clothing elements described in the proposal. The server then adjusts material parameters, such as diffuse color, roughness, and texture scale, to approximate the colors and patterns indicated by the proposal. When no suitable base asset exists, the server may use a three-dimensional content generation technique, such as a neural radiance field or a three-dimensional generative model trained on clothing shapes, to synthesize a new mesh.

The server adapts the three-dimensional clothing models to body shape data associated with the user. The user may provide body measurements or pose data, or the server may estimate body shape from one or more images captured by the terminal. The server uses a parametric human body model to represent body shape data. The server computes deformation of clothing meshes to conform to the target body shape using skinning algorithms and physics-inspired fitting algorithms. The server thereby generates three-dimensional clothing models that correctly follow the user's body contours in the virtual space, enhancing realism and avoiding excessive distortions.

The server transmits the three-dimensional clothing models and associated display control information to the terminal. The display control information includes scene configuration parameters such as camera position, lighting configuration, and object placement. The server encodes the models in a standardized three-dimensional file format and compresses them when appropriate to reduce communication load. The server thereby reduces the processing burden on the terminal, which needs only to load and render the transmitted models using its graphics hardware.

The terminal receives the three-dimensional clothing models and display control information from the server. The terminal loads the three-dimensional assets into its graphics engine and displays the virtual space on its display device. In the case of smart glasses, the terminal superimposes the avatar and clothing models onto the real-world environment using an augmented reality framework. In the case of a smartphone, the terminal renders the models in a virtual scene or overlays them onto the camera view. The terminal receives user inputs such as touch gestures or head movements and updates the view accordingly.

The user observes the outfit proposals and the try-on simulations. The user may provide evaluation information by selecting preferred outfits, rejecting others, or providing ratings. The server receives the evaluation information from the terminal and updates user preference models and similarity parameters. The server adjusts weighting factors in the similarity calculation so that feature dimensions corresponding to favored styles become more prominent. The server also modifies prompt sentence templates, for example, by reinforcing descriptive phrases related to preferred styles or by suppressing descriptors associated with rejected patterns.

The server, through this feedback loop, sequentially and adaptively changes the instruction content to the generative AI model. The server thus improves the quality and personalization of generated outfit proposals over time while simultaneously improving the efficiency of similarity search, because the server can reduce candidate spaces based on learned preferences.

This architecture provides technical effects beyond simple automation of human stylist tasks. The use of learned numerical vectors and approximate nearest neighbor search substantially reduces the time and computational resources required to locate relevant outfit examples in large image collections. The structured prompt generation, driven by machine-interpretable features and similarity results, reduces variability and improves the convergence of the generative AI model outputs, thereby limiting unnecessary re-generation cycles. The integration of three-dimensional model generation and body-shape adaptation into the same data flow improves memory locality and minimizes redundant conversions between data formats, which in turn lowers latency for virtual try-on rendering on the terminal. The feedback-driven adjustment of similarity parameters and prompt components enhances both accuracy and computational efficiency, as the system incrementally focuses its search and generation on relevant subspaces of the data.

The server, by implementing specific neural network architectures, loss functions, optimization schemes, and index structures, and by defining explicit data structures for feature information, outfit image data, prompt sentences, and three-dimensional models, provides concrete improvements to computer technology in the domains of image retrieval, generative modeling control, and three-dimensional rendering coordination. The terminal, by relying on the pre-processed and structured outputs from the server, can render complex virtual try-on scenes using reduced computational resources, thus enabling responsive interaction even on resource-constrained devices. The user thereby experiences accurate, fast, and adaptive outfit proposals and try-on simulations that are made possible by the described technical configuration and processing.

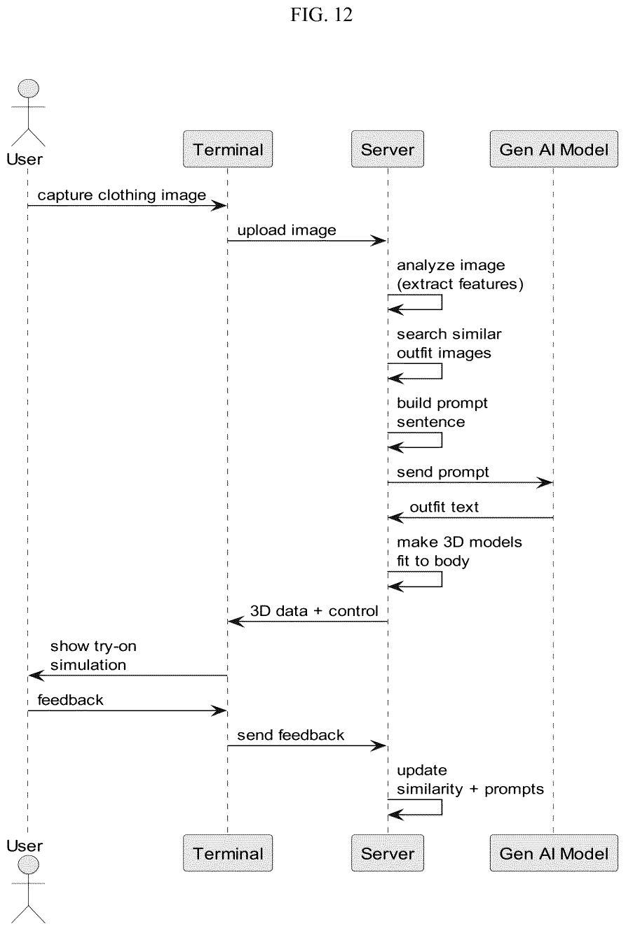

The following describes the processing flow using FIG. 12.

### Step 1:

The user operates the terminal to capture a clothing image.

The terminal activates a camera device and displays a live preview on the display. The user adjusts the position of the clothing item within the preview and triggers capture through a touch input, gesture, or voice command. The terminal encodes the captured frame as an image file in a compressed format and stores the file in local storage.
Input: physical clothing item and user input (capture command).
Output: digital image data representing the clothing item.

### Step 2:

The terminal prepares the clothing image for transmission and sends it to the server.

The terminal reads the stored image file, assigns a temporary identifier, and constructs a network request including the image data and basic metadata such as user identifier, capture time, and device information. The terminal establishes a secure connection to the server and uploads the image data.
Input: local image data and user identifier.
Output: network request containing image data and metadata transmitted to the server.

### Step 3:

The server receives and stores the uploaded clothing image data.

The server accepts the network request, performs validation of file format and size, and associates the image data with a new clothing image record. The server writes the image data to a storage subsystem and inserts a reference and metadata into a database. The server assigns a clothing image ID and returns an acknowledgment to the terminal.
Input: uploaded image data and metadata from the terminal.
Output: stored clothing image record and a clothing image ID.

### Step 4:

The server performs image recognition processing to extract feature information from the clothing image.

The server loads the clothing image corresponding to the clothing image ID and converts the image into a standardized tensor representation by resizing, normalizing color channels, and padding or cropping as needed. The server inputs the tensor into a convolutional neural network configured with learned weights. The server performs a forward pass through multiple convolution layers, non-linear activation layers, and pooling layers to compute a high-dimensional numerical vector at an embedding layer. The server also reads outputs from classification heads to derive attributes such as color, shape, pattern, material, and category.
Input: clothing image data associated with the clothing image ID.
Output: feature information including a numerical vector and attribute labels describing the clothing.

### Step 5:

The server indexes and retrieves similar outfit image data based on the feature information.

The server accesses an existing feature index containing numerical vectors corresponding to outfit images acquired from one or more information providing services. The server computes similarity scores between the clothing numerical vector and the outfit numerical vectors using a predefined similarity function such as cosine similarity. The server executes an approximate nearest neighbor search in the index to efficiently identify top-ranked outfit vectors. The server selects a subset of outfit images whose similarity scores exceed a threshold or are within the top N. The server retrieves metadata such as tags, captions, and pre-parsed clothing descriptions for the selected outfit images.
Input: clothing numerical vector and feature index of outfit numerical vectors.
Output: a list of outfit image data with high similarity and associated metadata.

### Step 6:

The server constructs a prompt sentence for a generative AI model from the feature information and the similar outfit image data.

The server converts the feature information into natural language descriptors, such as “red cable-knit wool sweater, slightly oversized, casual style.” The server summarizes each selected outfit image by combining its clothing descriptions and metadata into short textual examples. The server merges these descriptors and examples into a prompt structure containing: a section describing the user's clothing item, a list of example outfits, and explicit instructions describing the number of outfit candidates, required output elements, and style constraints. The server formats these sections into a single coherent prompt sentence.
Input: feature information of the clothing and metadata of similar outfit image data.
Output: a textual prompt sentence suitable for input to a generative AI model.

### Step 7:

The server optionally adjusts the prompt sentence based on condition information received from the user.

The server acquires condition information from the terminal, including preference information, usage scene information, season information, body shape information, and budget information. The server parses these data and derives constraints and preference descriptors. The server incorporates such descriptors into the prompt sentence by appending or modifying sentences that specify desired style, formality, temperature suitability, fit, and price range. The server thereby refines the instruction content so that the generative AI model receives explicit contextual constraints.
Input: initial prompt sentence and user condition information.
Output: an adjusted prompt sentence reflecting the user's conditions.

### Step 8:

The server sends the prompt sentence to a generative AI model and obtains outfit proposal information.

The server tokenizes the prompt sentence and submits the token sequence to a generative AI model, such as a transformer-based language model, through an inference interface. The server configures generation parameters including maximum output length and randomness controls. The generative AI model processes the input tokens using attention mechanisms and generates an output token sequence representing multiple outfit descriptions. The server receives the output, decodes the tokens into text, and parses the text into structured outfit proposal information, identifying individual outfits, their constituent clothing elements, and textual descriptions.
Input: prompt sentence and model configuration parameters.
Output: structured outfit proposal information describing multiple outfit candidates.

### Step 9:

The server generates or selects three-dimensional clothing models corresponding to clothing elements in the outfit proposal information.

The server analyzes each outfit proposal and extracts clothing element types such as tops, bottoms, footwear, and accessories along with color and pattern attributes. The server searches a three-dimensional asset library for base meshes whose categories and shapes match the clothing element types. The server assigns base meshes to each element and adjusts mesh material properties including color values, texture coordinates, and pattern overlays to approximate the described attributes. When a suitable base mesh is not available, the server invokes a three-dimensional generation pipeline to synthesize new mesh data according to the element description.
Input: outfit proposal information and three-dimensional asset library.
Output: a set of three-dimensional clothing models corresponding to the clothing elements of each outfit proposal.

### Step 10:

The server adapts the three-dimensional clothing models to body shape data associated with the user.

The server obtains body shape data describing the user's body dimensions or a parametric body model. The server computes deformation parameters for each clothing model using a skinning algorithm that binds mesh vertices to skeleton joints. The server adjusts vertex positions to fit the clothing models onto the body model while preserving garment structure. The server simulates drape and fit using simplified physical constraints if necessary. The server thereby generates user-adapted three-dimensional clothing models for all outfit proposals.
Input: three-dimensional clothing models and user body shape data.
Output: deformed three-dimensional clothing models fitted to the user's body model.

### Step 11:

The server compiles display control information and transmits data to the terminal.

The server defines a virtual scene configuration including camera position, lighting parameters, and arrangement of the avatar and clothing models. The server packages the fitted three-dimensional clothing models and scene parameters into a transmission payload. The server compresses model data if required and sends the payload over a communication network to the terminal, along with identifiers linking each model set to corresponding outfit proposals.
Input: user-adapted three-dimensional clothing models and scene configuration parameters.
Output: transmitted three-dimensional model data and display control information delivered to the terminal.

### Step 12:

The terminal receives the three-dimensional model data and prepares rendering of a virtual space.

The terminal stores the received three-dimensional model data and display control information in local memory. The terminal initializes a three-dimensional graphics engine and loads the avatar model, clothing models, and lighting configuration. The terminal constructs a scene graph structure representing objects and transformations. The terminal binds clothing models to the avatar skeleton using the deformation information received from the server.
Input: transmitted three-dimensional model data and display control information from the server.
Output: an initialized three-dimensional scene ready for rendering on the terminal.

### Step 13:

The terminal displays a try-on simulation and accepts user interaction.

The terminal renders the virtual space on the display or within an augmented reality view, presenting the avatar wearing the clothing corresponding to one of the outfit proposals. The terminal processes input events such as touch gestures, controller actions, or head movements and updates camera orientation, zoom level, and selected outfit accordingly. The terminal switches loaded clothing models when the user selects another outfit proposal and redraws the scene.
Input: scene data, user interaction events, and rendering commands.
Output: visual frames of the try-on simulation presented to the user.

### Step 14:

The user evaluates the outfit proposals and provides feedback.

The user observes the displayed try-on simulations and selects preferred outfits, rejects others, or assigns ratings using interface controls. The user may also input textual comments or select tags that describe satisfaction or dissatisfaction. The terminal records these actions as evaluation information and transmits the evaluation information to the server.
Input: visual try-on simulation and interactive controls.
Output: evaluation information indicating user preferences and reactions.

### Step 15:

The server updates similarity parameters and prompt generation rules based on the evaluation information.

The server receives evaluation information from the terminal and correlates it with the clothing feature information and outfit proposal information. The server adjusts weighting factors in the similarity function to emphasize feature dimensions corresponding to favored attributes and de-emphasize those associated with rejected outfits. The server also updates prompt generation templates by adding or reducing emphasis on specific style terms, usage scenes, or constraints. The server stores updated parameters and templates in configuration storage for use in subsequent executions.
Input: evaluation information, prior similarity parameters, and existing prompt generation templates.
Output: updated similarity calculation parameters and revised prompt generation rules for future prompt sentences sent to the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional outfit recommendation systems generally rely on rule-based engines or static similarity metrics operating on locally stored item catalogs. Such systems typically use simple tags, categories, or color codes and do not fully leverage large-scale image data and natural language data available on external information sharing services. As a result, these systems often fail to generate context-aware recommendations that reflect a user's real-world wardrobe, personal attributes, and situation, and they cannot effectively track or exploit rapidly changing fashion trends.

Further, while generative AI models and large-scale image recognition models have recently become available, existing systems treat these models in isolation. In many cases, the generative AI model is merely used as a text generator, and an image recognition model is merely used as a classifier or feature extractor. There is no integrated computational framework that (i) derives prompt sentences from structured visual feature data and user context, (ii) uses the generative AI model to generate high-quality search terms and identifiers for external services, and (iii) feeds back large-scale, trend-reflective outfit image data into a similarity computation pipeline that is anchored in the user's own clothing features.

In addition, traditional systems incur significant computational overhead when naively searching and ranking large volumes of external image data, because they do not define a unified feature space in which both user-owned clothing images and external outfit images can be compared efficiently. This leads to latency, scalability issues, and suboptimal utilization of computing resources, and hinders deployment on resource-constrained environments.

Accordingly, there is a need for an improved computer-implemented technique that tightly integrates generative AI models, prompt sentence generation, and image recognition models into a single processing flow. Such a technique should (a) automatically generate and refine prompt sentences based on feature amounts derived from user clothing images and user condition information, (b) acquire relevant outfit image data from external information sharing services based on search terms and identifiers obtained from a generative AI model, (c) map both user clothing and external outfit images into a unified feature space to enable efficient similarity computation, and (d) rank outfit candidates based on combined similarity scores and popularity indices. By solving these computational problems, the system can provide more accurate, context-sensitive, and trend-aware outfit recommendations while improving the efficiency and technical performance of the underlying computer resources.

The specific processing by the specific processing unit 290 of the data processing device 12 in Example 2 is realized by the following means.

The present invention provides a server comprising a processor configured to acquire, from a terminal operated by a user, clothing images representing clothing items possessed by the user and condition information including attributes and a situation of the user, to analyze the acquired clothing images by using an image processing apparatus and a trained image recognition model to extract feature amounts representing at least a color, a shape, a pattern, and a category of each clothing item, to generate a prompt sentence including search instruction content for acquiring outfit image data from an information sharing service on the basis of the condition information and the feature amounts and to input the prompt sentence to a generative AI model to acquire search terms and identification information for the information sharing service, to acquire outfit image data and associated information from the information sharing service on the basis of the search terms and the identification information acquired from the generative AI model, to analyze the acquired outfit image data by using the trained image recognition model to extract feature amounts belonging to a same feature space as the feature amounts of the clothing items possessed by the user, to calculate similarity between the feature amounts of the clothing items possessed by the user and the feature amounts of the outfit image data and to select outfit candidates to be proposed to the user on the basis of the similarity and the condition information, and to output, to the terminal, combination information of clothing items corresponding to the selected outfit candidates and the outfit image data corresponding to the selected outfit candidates, and further configured, in some embodiments, to dynamically generate and adjust the prompt sentence based on the user condition information and the clothing feature amounts and to rank the outfit candidates by integrating evaluation values based on the similarity and popularity indices of the outfit image data in the information sharing service. This enables the server to cooperatively use the generative AI model and the image recognition model as interconnected computing components, to efficiently retrieve and structure external outfit image data in a unified feature space, to reduce computational overhead in similarity calculation and ranking across large-scale image datasets, and to generate improved, context-aware outfit recommendations that more accurately reflect both the user's wardrobe and current trends as represented in the information sharing service.
The term “processor” refers to a hardware or virtual computation unit, such as a central processing unit or a processing core in a computing device, that executes machine-readable instructions to perform the operations described in this specification.
The term “terminal” refers to an information processing device operated by a user, such as a portable communication device or a general-purpose computing device, that is configured to capture images, transmit data to a server, and present information to the user.
The term “user” refers to a person who owns or manages clothing items and interacts with the terminal and the system to obtain outfit recommendations.
The term “clothing image” refers to digital image data that visually represents at least one clothing item possessed by the user and that is captured, stored, or transmitted by the terminal or the server.
The term “clothing item” refers to an article of apparel or an accessory worn on a human body, including upper garments, lower garments, outerwear, footwear, or similar wearable objects.
The term “condition information” refers to information related to a context for recommending an outfit, including at least a user attribute and a user situation, and optionally including additional preference or constraint information.
The term “attribute” refers to a characteristic of the user such as age, gender, body type, or other personal profile information used by the system to tailor an outfit recommendation.
The term “situation” refers to a usage scenario or event in which the user intends to wear an outfit, such as a date, a business meeting, a formal ceremony, or a casual outing.
The term “image processing apparatus” refers to a hardware or software component, including a processing circuit or an image processing library, that performs pre-processing or analysis of digital image data such as resizing, cropping, or normalization.
The term “trained image recognition model” refers to a machine-learned model, such as a neural network model trained on image data, that is configured to extract feature amounts from image data or to classify visual characteristics of objects depicted in the image data.
The term “feature amount” refers to a numerical representation or vector that encodes visual characteristics of an image, including at least one of color, shape, pattern, category, or similar attributes of a clothing item or an outfit.
The term “category of a clothing item” refers to a type label assigned to a clothing item, such as upper garment, lower garment, one-piece, outerwear, footwear, or accessory, that is used to group and compare clothing items.
The term “prompt sentence” refers to a natural language expression or structured textual string that is provided as input to a generative AI model to request generation of output data such as search terms or identifiers.
The term “search instruction content” refers to information included in the prompt sentence that specifies a search objective, including at least a target platform, a target style, or conditions for retrieving outfit image data.
The term “generative AI model” refers to an artificial intelligence model, such as a generative language model, that produces text or other data in response to an input prompt and that is used to generate search terms or identifiers for external services.
The term “search term” refers to a keyword, phrase, or tag generated by the generative AI model and used by the server to query an information sharing service for outfit image data.
The term “identification information” refers to information, such as an identifier, a link, a tag, or a structured query parameter, that is obtained from the generative AI model and used to specify or filter data to be retrieved from an information sharing service.
The term “information sharing service” refers to a network-based service, such as an online platform or a content distribution service, that stores and provides access to user-generated or curated image data including outfit images.
The term “outfit image data” refers to digital image data and associated metadata that depict at least one coordinated set of clothing items worn by a subject and that are acquired from an information sharing service.
The term “associated information” refers to additional data accompanying outfit image data, including at least one of captions, tags, popularity indicators, or time information, that can be used for analysis or ranking.
The term “same feature space” refers to a common representation space in which feature amounts of user clothing images and feature amounts of outfit image data are expressed as comparable vectors such that similarity can be computed between them.
The term “similarity” refers to a quantitative measure of correspondence between two feature amounts, computed by a mathematical operation such as cosine similarity, distance-based similarity, or another comparison metric.
The term “outfit candidate” refers to a proposed combination of clothing items, including at least one clothing item possessed by the user, selected by the processor on the basis of similarity and condition information for presentation to the user.
The term “combination information” refers to data that specifies how multiple clothing items are to be coordinated together as an outfit candidate, including identifiers of items and optionally arrangement or styling instructions.
The term “popularity index” refers to a quantitative value derived from interaction data or metadata in an information sharing service, such as numbers of views, likes, shares, or similar engagement metrics, that indicates a level of popularity of outfit image data.

In one embodiment, a server, a terminal, and a network form a coordinated system that implements the claimed invention. The server includes at least one processor, a memory, a non-transitory storage device, and a network interface. The terminal includes a processor, a camera module, a display unit, a user input unit, a memory, and a communication module. The server and the terminal communicate over a communication network such as a packet-switched network.

The terminal captures clothing images by using the camera module controlled through an operating system camera framework. The terminal encodes captured images as digital image data, for example in JPEG or PNG format, and stores the image data in a local storage area.

The terminal also presents user interface components that allow a user to input attribute information such as age and gender, and situation information such as “date,” “business meeting,” or “wedding.” The terminal transmits the clothing images and the condition information to the server through the communication module using a structured data format such as a JavaScript Object Notation message encapsulated in a hypertext transfer protocol over a secure transport protocol.

The server stores received clothing images in a storage device and maintains a data structure that associates a user identifier, a file path, and an image identifier with each clothing image. The server also stores condition information in a data record associated with the user identifier. The server uses a database management system to maintain tables that include user profile records, clothing item records, feature vector records, and outfit image records. Each clothing item record references the corresponding clothing image identifier and includes fields for category, color, and pattern. Each feature vector record stores a numerical array that represents visual feature amounts derived from the corresponding image.

The server analyzes each clothing image by using an image processing library, such as a general-purpose image manipulation library, to perform resizing, cropping, and normalization of pixel values. The server converts each pre-processed image into a tensor representation suitable for input to a trained image recognition model. The server executes the trained image recognition model on a computation unit such as a graphics processing unit configured with a neural network inference framework, for example a framework of the convolutional neural network type.

In one example, the server uses a convolutional neural network having multiple convolutional layers, pooling layers, and fully connected layers. The server configures initial convolutional layers to extract low-level features such as edges and color gradients, and configures deeper layers to extract mid-level and high-level features corresponding to clothing patterns, silhouettes, and categories. The server obtains, from an intermediate or penultimate layer of the neural network, a feature vector of fixed dimension, such as 512 or 2048 elements, that represents the feature amounts of the clothing image in a high-dimensional feature space. The server stores this feature vector as the feature amount of the clothing item. The server also obtains, from a final classification layer, a probability distribution over clothing categories and selects a category label having the highest probability as the category of the clothing item.

The server configures and trains the image recognition model by using a large training dataset that includes labeled clothing images. During training, the server initializes network weights, performs a forward pass to compute predicted category probabilities, computes a loss value such as a cross-entropy loss between predicted labels and ground truth labels, and uses a gradient-based optimization algorithm such as stochastic gradient descent or Adam to update the weights. The server may apply data augmentation techniques such as random cropping, horizontal flipping, color jitter, and random rotation to increase robustness of the model against variations in photographing conditions. The server may also perform fine-tuning by using images that are similar to the user population of interest, thereby improving recognition accuracy for clothing types and patterns that frequently appear in real use cases.

The server maintains the feature vectors of all clothing images in a feature store. The server may use a vector index structure implemented by a similarity search library, which supports fast approximate nearest neighbor search in a high-dimensional space. The server normalizes each feature vector, for example by dividing by its L2 norm, to obtain a unit vector, which simplifies computation of cosine similarity. This data structure arrangement allows the server to perform similarity computations between a user's clothing items and a large number of external outfit images with reduced computational cost.

The server acquires the condition information from the database, including the user's attributes and situation. The server normalizes age into age groups, maps gender into standardized codes, and maps situation text into a controlled vocabulary of situation labels. The server combines this normalized condition information with clothing category and color information derived from the feature amounts. The server generates a prompt sentence for a generative AI model by concatenating or formatting these elements into a natural language instruction. For example, the server may generate prompt sentences such as:
“For a woman in her 30s, date outfit coordination. Please suggest Japanese hashtags and search keywords that are popular on Instagram.”
“For a man in his 20s, casual outfit coordination for commuting to school. Please generate English and Japanese keywords for searching images on Pinterest.”
“For a man in his 40s, business-casual office outfit coordination. Please list 10 candidate hashtags for finding Instagram posts.”
“For a woman in her 30s attending a wedding, dress outfit coordination. Please output related hashtags and search phrases used on Instagram.”

The server dynamically adjusts the content of the prompt sentence depending on the feature amounts. For example, if the clothing feature amounts indicate that the user possesses many coat-type items with neutral colors, the server inserts terms such as “trench coat” or “neutral colors” into the prompt sentence. This dynamic construction of the prompt sentence ties the input to the generative AI model directly to the feature space representation computed from images, thereby enabling the generative AI model to produce search terms that match both the user's wardrobe and the usage situation.

The server accesses a generative AI model hosted on an external or internal computation resource. The server can use a generative language model having a transformer-based architecture with multiple self-attention layers and feed-forward layers. The server configures the generative AI model with parameters such as a vocabulary size, an embedding dimension, and a number of attention heads. During training of such a generative AI model, a training system minimizes a loss function such as cross-entropy between predicted token sequences and reference text sequences, using an optimization algorithm similar to that used for the image recognition model. The server, at runtime, sends the prompt sentence to an application programming interface that provides inference for the generative AI model and receives a generated text response.

The server parses the text response returned from the generative AI model to extract search terms, candidate hashtags, and identification information that can be used with an information sharing service. For example, the generative AI model may output hashtags such as “#dateoutfit”, “#30soutfit”, “#trenchcoatoutfit” and natural language search phrases. The server performs tokenization of the generated text, removes stop words, normalizes casing and script variations, and groups tokens into candidate search queries. The server may store these tokens in a search term data structure that includes a field for term type, a field for language, and a field for associated condition information, so that the system can reuse or analyze search behavior.

The server then communicates with an information sharing service through a network interface. The server uses the search terms and identification information obtained from the generative AI model to construct queries to the information sharing service, for example by placing hashtags or keywords into request parameters. The server invokes the application programming interface provided by the information sharing service, receives outfit image data and associated metadata such as captions, tags, and engagement metrics, and stores this data in an outfit image record structure. Each outfit image record includes a reference to an image location, text fields for captions and tags, and numeric fields for popularity indices derived from engagement metrics.

The server applies the same or a compatible image recognition model to the external outfit image data to extract feature amounts in the same feature space as the user clothing feature amounts. The server thus obtains, for each external outfit image, a feature vector of the same dimensionality and scaling as the user clothing vectors, so that a similarity measure such as cosine similarity or Euclidean distance can be applied consistently. The server can also use captured tags or captions to infer additional attributes such as style labels, and may store these as auxiliary attributes alongside the feature vectors.

The server computes similarity values between the feature vectors of the user's clothing items and the feature vectors of the external outfit images. The server may compute a pairwise similarity matrix or an aggregated similarity score between a set of user clothing vectors and each external outfit vector. For example, the server may compute cosine similarity by taking the dot product between normalized vectors. The server can weight particular dimensions of the feature vectors more heavily when those dimensions correspond to attributes that are important for the current situation, such as color harmony for a formal event. The server can also incorporate the condition information into the similarity scoring by applying a weighting factor to outfits that are labeled with matching situations or style descriptors.

The server ranks the outfit candidates based on the similarity scores and on popularity indices derived from engagement quantities in the information sharing service. The server may compute a composite score that is a weighted sum of a similarity score and a normalized popularity index. The server may tune the weighting parameters empirically or dynamically based on system performance metrics. By combining similarity and popularity in this way, the server selects outfit candidates that not only match the user's wardrobe in the feature space but also reflect trends and preferences present in the larger user community of the information sharing service.

The server generates, for each selected outfit candidate, combination information that specifies which of the user's clothing items can be combined to approximate the external outfit. To generate this combination information, the server analyzes the clothing categories and colors of both the user's items and the external outfit and applies heuristic rules or learned rules that map external clothing components such as “top,” “bottom,” and “outerwear” to corresponding user items. The server encodes this combination information as a structured record that lists identifiers of selected user clothing items, identifiers or links of external outfit images, and explanatory text describing the coordination.

The server transmits the combination information and the associated outfit image data to the terminal through the network interface. The terminal receives the data and renders the recommendations on the display unit. The terminal can present, for each recommended outfit, thumbnails of the user's clothing items and a reference image from the information sharing service, along with explanatory text. The user views the displayed recommendations and may provide feedback such as a positive evaluation or a negative evaluation. The terminal transmits feedback information to the server, which stores it in a feedback data structure linked to the corresponding outfit candidate and user identifier. The server may use this feedback to adjust weighting parameters in the similarity and ranking computations, thereby improving relevance over time.

The technical effect of this architecture is not limited to automation of manual outfit selection. The server improves computer technology by (i) reducing network load through the generation of targeted search terms that limit the volume of data retrieved from the information sharing service, (ii) improving processing speed and scalability by organizing feature vectors in a high-dimensional index structure that enables sub-linear approximate nearest neighbor search, (iii) increasing recommendation precision by using a unified feature space to directly compare user-owned clothing images and external outfit images, and (iv) optimizing use of computational resources by decoupling feature extraction, generative prompt processing, and similarity computation into modular components that can be executed on specialized hardware such as graphics processing units.

The use of a generative AI model in this system is technically distinct from merely replacing a human content creator. The server converts image-derived feature amounts and structured condition information into prompt sentences, obtains structured search terms and identifiers, and feeds these back into a retrieval pipeline that interacts with an information sharing service. The generative AI model therefore functions as a dynamic query generator whose input is grounded in high-dimensional image features. This closed-loop interaction between image recognition and generative language modeling results in more accurate and efficient retrieval than conventional static keyword-based querying, because the generative AI model extrapolates from the feature space into the space of commonly used tags and phrases on the information sharing service.

Multiple variations are possible within the scope of the invention. The server may use different neural network architectures such as residual networks, dense networks, or vision transformer networks for image recognition. The feature vector dimensionality, normalization method, and similarity metric may be varied. The generative AI model may be replaced by another generative model that uses a different architecture or training method, as long as it accepts a prompt sentence and outputs text that can be parsed into search terms and identifiers. The information sharing service may be any network-based system providing image content and associated metadata. The terminal may be a portable device, a stationary device, or a mixed-reality display device, as long as it is able to capture clothing images, transmit data, and present recommendations to the user.

By integrating these components in the described manner, the system improves the functioning of the computer system itself. The server reduces redundant data transfer and computation by confining heavy feature extraction and similarity computations to the server-side and by restricting external queries to pertinent subsets of the information sharing service. The system achieves higher accuracy and responsiveness compared to a simple rule-based or tag-based system that does not operate in a unified feature vector space and does not use a generative AI model to adapt its querying behavior.

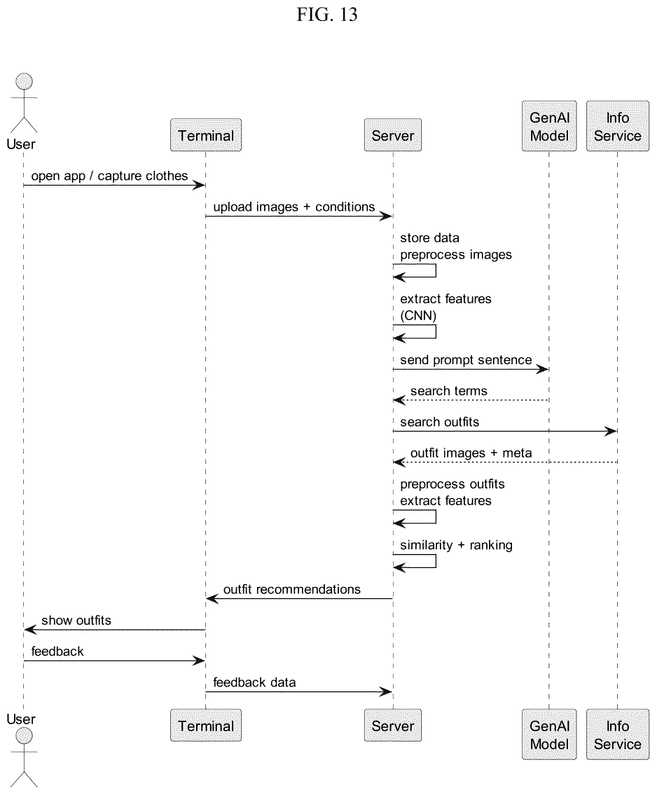

The following describes the processing flow using FIG. 13.

### Step 1:

The user operates the terminal to launch an outfit recommendation application.

The terminal initializes a camera framework and activates a camera module to capture clothing images.
Input: real-world clothing items owned by the user and control signals from the user.

The terminal converts optical signals from the camera sensor into digital image data, encodes the data as image files (for example, JPEG or PNG), and stores the files in local memory.
Output: digital clothing images stored on the terminal.

### Step 2:

The terminal presents a gallery interface and a form for user attributes and situation.

The user uses the terminal to select one or more clothing images and to input condition information such as age, gender, and situation (for example, date, office, wedding).
Input: stored clothing images and user-entered attribute and situation values.

The terminal packages selected image files and condition information into a structured message (for example, a JSON object plus multipart image data) and transmits the message to the server via a network connection.
Output: an upload request containing clothing images and condition information sent to the server.

### Step 3:

The server receives the upload request through a network interface.

The server validates authentication data, file formats, and data sizes.

Input: clothing image data stream and condition information from the terminal.

The server writes the image data to a storage device, generates unique identifiers for each clothing image, and inserts records into a database that associate a user ID, an image ID, and a storage path. The server stores the condition information in a user profile table linked by the user ID.
Output: stored image files and database records for clothing images and condition information.

### Step 4:

The server retrieves identifiers of newly stored clothing images from the database.

The server loads corresponding image files from the storage device into memory.
Input: clothing image files and associated metadata.

The server uses an image processing library to resize, crop, and normalize pixel values, converting each image into a numerical tensor suitable for a trained image recognition model.
Output: pre-processed image tensors representing each clothing image.

### Step 5:

The server applies a trained convolutional neural network to each pre-processed image tensor.
Input: image tensors for user clothing images.

The server performs forward inference through multiple convolutional, pooling, and fully-connected layers, generating intermediate activations and final logits. The server extracts a feature vector from an intermediate or penultimate layer as a high-dimensional representation of color, shape, and pattern. The server selects a clothing category label by taking the maximum probability from the final classification output.
Output: feature vectors and category labels for each clothing image.

### Step 6:

The server stores the extracted feature vectors and category labels in a feature store.
Input: feature vectors, category labels, and associated image IDs.

The server normalizes each feature vector (for example, by L2 normalization) and writes normalized vectors into a vector index structure that supports efficient similarity search. The server links each vector record to the corresponding clothing image ID and user ID in the database.
Output: indexed and normalized feature vectors associated with user clothing items.

### Step 7:

The server retrieves the condition information from the user profile table.
Input: stored attributes (for example, age, gender) and situation labels for the user, as well as clothing category and color information derived from the feature vectors.

The server normalizes the condition information (for example, mapping age to an age group, mapping situation text to a controlled label) and combines these normalized values with representative clothing attributes. The server then constructs a prompt sentence in natural language that encodes age group, gender, situation, clothing categories, and a target information sharing service.
Output: a structured prompt sentence prepared for input to a generative AI model.

Step 8:

The server sends the generated prompt sentence to a generative AI model via an application programming interface.
Input: the prompt sentence expressing the user's attributes, situation, clothing characteristics, and target information sharing service.

The server transmits the prompt text to the generative AI model and receives generated text in response. The generative AI model, by applying a transformer-based architecture, computes token probabilities conditioned on the prompt sentence and samples or decodes a sequence of tokens encoding search terms, hashtags, and other identifiers.
Output: generated text containing search terms, hashtags, and identification information for retrieving outfit image data.

### Step 9:

The server parses the generated text received from the generative AI model.
Input: generated text containing candidate search terms and identifiers.

The server tokenizes the text, filters out irrelevant or duplicate tokens, and groups remaining tokens into canonical search terms and identification parameters. The server may classify each token as a hashtag, keyword phrase, or filter condition and store these in a search term data structure.
Output: a set of cleaned and structured search terms and identification information.

### Step 10:

The server communicates with an information sharing service using the structured search terms.
Input: search terms and identification information derived from the generative AI model.

The server constructs query requests (for example, including hashtags and keyword parameters) to the information sharing service's application programming interface and sends these over the network. The server receives response messages containing outfit image locations, captions, tags, and engagement metrics. The server writes outfit image records to the database, including links to image resources and associated metadata.
Output: stored outfit image data records and associated metadata obtained from the information sharing service.

### Step 11:

The server downloads or accesses the outfit image data referenced in the outfit image records.
Input: outfit image locations and associated metadata.

The server loads each outfit image file into memory and applies the same image pre-processing procedures used for user clothing images, creating normalized tensors. The server then applies the same trained image recognition model to these tensors, performing forward inference to obtain feature vectors in the same feature space as the user clothing feature vectors.
Output: feature vectors for external outfit images in a unified feature space.

### Step 12:

The server stores the outfit feature vectors in the feature store.
Input: outfit feature vectors and associated outfit image identifiers.

The server normalizes the outfit feature vectors and inserts them into the vector index structure using the same normalization method as for user clothing items. The server associates each outfit vector with metadata such as style tags and popularity indices derived from the information sharing service.
Output: indexed and normalized feature vectors for outfit images, linked to metadata and popularity information.

### Step 13:

The server computes similarity scores between user clothing feature vectors and outfit feature vectors.
Input: normalized feature vectors for user clothing items and normalized feature vectors for external outfit images.

The server performs vector operations, such as dot products, to compute cosine similarity between each outfit feature vector and one or more aggregated user clothing vectors. The server may compute an aggregated wardrobe vector by averaging or weighted averaging the user's clothing vectors and then computing similarity between this aggregated vector and each outfit vector.
Output: similarity scores quantifying how well each outfit image matches the user's clothing feature space.

### Step 14:

The server ranks outfit candidates based on similarity scores and popularity indices.

Input: similarity scores, popularity indices, and condition information such as situation labels.

The server calculates a composite ranking score for each outfit image, for example by computing a weighted sum of a normalized similarity score and a normalized popularity index, possibly adjusted by situation-matching weights. The server sorts the outfit images according to the composite scores and selects a subset of top-ranked outfit images as outfit candidates.
Output: a ranked list of outfit candidates selected for recommendation.

### Step 15:

The server derives combination information for user clothing items based on the selected outfit candidates.
Input: selected outfit candidates, their feature vectors, and the user's clothing item feature vectors and category labels.

The server compares clothing categories and color attributes between outfit candidates and user clothing items. The server applies mapping rules or learned mappings (for example, matching “outerwear” category to user coats) to determine which user items can best approximate each external outfit. The server builds combination records that list selected user item identifiers and associated outfit image identifiers, and generates explanatory text describing how the items form a coordinated outfit.
Output: combination information records linking user clothing items to selected outfit candidates with explanatory descriptions.

### Step 16:

The server transmits the combination information and related outfit image data to the terminal.
Input: combination information records and references to outfit images.

The server formats the data as a response message, including user clothing image identifiers, external outfit image locations, similarity-based ranking information, and explanatory text. The server sends this message through the network interface to the terminal.
Output: a recommendation response containing outfit candidates and combination details delivered to the terminal.

### Step 17:

The terminal receives the recommendation response from the server.
Input: recommendation response containing identifiers for user clothing images, references to outfit images, and explanatory text.

The terminal resolves local clothing image identifiers to corresponding image files, optionally downloads thumbnails of external outfit images, and composes graphical layouts that present side-by-side views of user items and reference outfits. The terminal renders these layouts on the display unit along with explanatory text, and allows the user to scroll and select recommendations.
Output: visual display of outfit recommendations and corresponding user interaction options.

### Step 18:

The user reviews the displayed outfit recommendations on the terminal.

The user uses the input unit to indicate preferences, for example by selecting “like,” “dislike,” or “save” on specific outfit candidates.
Input: displayed recommendations and user touch or button input.

The terminal encodes the user feedback as structured feedback data associated with outfit identifiers and transmits this feedback to the server.
Output: feedback data sent from the terminal to the server.

### Step 19:

The server receives and stores user feedback for further refinement.
Input: feedback data linked to outfit candidates and user identifiers.

The server updates feedback records in the database, associates preference labels with corresponding outfit candidates, and may adjust weighting parameters used in the composite ranking score calculation. The server can perform statistical analysis over accumulated feedback to recalibrate similarity weights, popularity weights, or prompt sentence patterns used for future generative AI model calls.
Output: updated feedback records and adjusted internal parameters that influence subsequent recommendation computations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented outfit recommendation systems typically rely on manually defined rules, simple attribute matching, or static lookup tables to generate suggestions. Such systems often treat user-provided clothing images and user input conditions merely as high-level tags, and do not fully exploit low-level image features or dynamically integrate emotional context. As a result, these systems are limited in personalization accuracy and cannot adaptively change recommendation behavior in response to nuanced visual characteristics of garments, fine-grained user feedback, or real-time emotional states.

Moreover, in many existing architectures, a generative AI model is used in an ad hoc manner, for example by sending only coarse text prompts describing user preferences. The underlying computing system does not systematically transform rich image-derived numerical features, similarity computations with large image repositories, and user feedback histories into structured, machine-generated prompt sentences. This leads to inefficient utilization of computing resources, underuse of available image-processing outputs, and a lack of consistent, reproducible interaction patterns with the generative AI model.

In addition, known approaches frequently process the output of a generative AI model as unstructured text, leaving substantial parsing and interpretation work to downstream application code or even to human users. This creates technical bottlenecks in the data flow: the system cannot easily map generated text back to specific clothing items, cannot attach structured semantic attributes such as style or emotion alignment, and cannot automatically generate consistent visual or three-dimensional presentation data for virtual try-on. Consequently, the graphical rendering pipeline and the inference pipeline remain loosely coupled, increasing latency and processing overhead in the system as a whole.

Furthermore, conventional systems generally lack a closed feedback loop between user evaluations and the generation of subsequent prompts to the generative AI model. While some systems may log user feedback, they do not programmatically incorporate this feedback into the prompt construction process, nor do they adjust similarity calculations or attribute weighting at the system level. This results in repeated generation of suboptimal recommendations and inefficient use of network and processor resources for iterative calls to remote AI services.

Therefore, there is a need for a computer-implemented system and method that (i) tightly integrates low-level image feature extraction, similarity computation, and user condition and emotion acquisition; (ii) automatically converts such multi-modal data into a structured prompt sentence for a generative AI model; (iii) programmatically parses and structures generative outputs for subsequent visual and three-dimensional rendering; and (iv) uses user feedback and operation history to adaptively refine prompt generation and recommendation behavior. Such a system should improve the overall functioning of the computer-based recommendation pipeline, reduce redundant processing, and enable more efficient and accurate generation and presentation of personalized outfit proposals.

The specific processing by the specific processing unit 290 of the data processing device 12 in Application Example 2 is realized by the following means.

The present invention provides a server comprising a processor configured to receive image information including clothing from an information processing terminal, perform pixel-level preprocessing and feature extraction on the image information to generate numerical feature data representing at least a color attribute, a shape attribute, a pattern attribute, and a category attribute of the clothing, generate numerical feature data of the same type for reference image information including outfits acquired from an external information sharing platform, and select one or more outfit candidates similar to the clothing by calculating similarity between the numerical feature data of the clothing and the numerical feature data of the reference image information, acquire condition information including at least a user attribute, a use scene, and a season from the information processing terminal, and acquire emotion state information of a user estimated by the information processing terminal or by an external computation resource, and generate a prompt sentence described in natural language, the prompt sentence defining processing content to cause a generative AI model to generate an outfit proposal or a decoration proposal based on the condition information, the emotion state information, the outfit candidates, and the numerical feature data of the clothing, input the prompt sentence to the generative AI model, acquire outfit proposal information output from the generative AI model, convert the outfit proposal information into structured data including at least component-wise item information, color attribute information, style attribute information, and emotion correspondence attribute information, and generate visual display data or three-dimensional display data associated with the image information of the clothing and the outfit candidates based on the outfit proposal information included in the structured data, and transmit the outfit proposal information and the visual display data to the information processing terminal. This enables improved utilization of computational resources and data pathways by tightly coupling image analysis, similarity computation, natural-language prompt construction, generative AI inference, and structured rendering preparation within a unified server-side pipeline, thereby enhancing the technical performance, responsiveness, and personalization accuracy of computer-based outfit recommendation and virtual try-on systems.
The term “processor” refers to a hardware computing element, such as a central processing unit or a programmable logic device, configured to execute instructions and perform arithmetic, logical, control, and input/output operations in order to implement the functions of the system.
The term “information processing terminal” refers to an electronic apparatus operated by a user, such as a mobile terminal, a wearable terminal, or a general-purpose computing terminal, that captures, stores, displays, and transmits information including image information and user input to the server.
The term “image information” refers to digital data representing visual content, including still images and sequences of images, that contain at least a depiction of clothing or outfits and are processable by an image processing algorithm.
The term “clothing” refers to wearable articles, including tops, bottoms, outerwear, footwear, and accessories, that are visually represented in the image information and are subjects of feature extraction and recommendation in the system.
The term “pixel-level preprocessing” refers to operations performed on image information at the level of individual pixels or groups of pixels, such as resizing, color conversion, noise reduction, normalization, or region-of-interest extraction, prior to higher-level feature extraction.
The term “feature extraction” refers to a computational process that transforms raw image information into numerical feature data representing characteristics of clothing, including but not limited to color attributes, shape attributes, pattern attributes, and category attributes.
The term “numerical feature data” refers to one or more numerical values, such as vectors, matrices, or tensors, that encode properties of image information or clothing in a form suitable for similarity calculation, classification, or input to a machine learning model.
The term “color attribute” refers to one or more numerical or categorical indicators representing color-related characteristics of clothing, such as hue, saturation, brightness, or color category.
The term “shape attribute” refers to one or more numerical or categorical indicators representing geometric characteristics of clothing, such as contour, silhouette, or proportion.
The term “pattern attribute” refers to one or more numerical or categorical indicators representing surface characteristics of clothing, such as stripes, checks, florals, solids, or other visual patterns.
The term “category attribute” refers to one or more numerical or categorical indicators representing a functional or semantic classification of clothing, such as top, bottom, outerwear, footwear, accessory, or similar category.
The term “reference image information” refers to image information obtained from an external information sharing platform or other data source that includes outfits or coordinated clothing examples used by the system as comparison samples.
The term “external information sharing platform” refers to a data-providing infrastructure, such as an online service or networked repository, that stores and supplies image information of outfits or clothing combinations for use in similarity calculation and recommendation.
The term “outfit” refers to a combination of two or more clothing items, optionally including accessories, that together form a coordinated style suitable for a particular user attribute, use scene, or season.
The term “outfit candidate” refers to a selected outfit derived from reference image information or generated combinations that exhibits a similarity to a user's clothing according to numerical feature data and similarity calculation.
The term “similarity” refers to a quantitative relation between two sets of numerical feature data, calculated by a similarity function such as inner product, cosine similarity, distance metric, or other comparison indicator.
The term “condition information” refers to structured data indicating constraints or preferences specified for recommendation, including at least user attributes, use scenes, and seasons.
The term “user attribute” refers to characteristic information related to a user, such as age range, gender attribute, body type attribute, style preference, or other demographic or preference parameters.
The term “use scene” refers to contextual information describing a situation in which an outfit is intended to be worn, such as work, formal event, casual outing, date, or seasonal event.
The term “season” refers to temporal or environmental context information such as spring, summer, fall, winter, or similar climatic classifications relevant to outfit selection.
The term “emotion state information” refers to data representing an estimated emotional condition of a user, such as joy, sadness, surprise, calmness, or other psychological states, obtained by analysis of sensor data or explicit user input.
The term “external computation resource” refers to a computing entity or service separate from the information processing terminal and the server, such as a remote inference engine or hosted analysis service, that provides emotion estimation or other computations.
The term “prompt sentence” refers to natural language text specifying instructions, context, and constraints that are supplied as input to a generative AI model to cause the generative AI model to perform a desired generation process.
The term “generative AI model” refers to a machine learning model, such as a generative language model or multimodal generative model, configured to produce output data, including natural language text or other media, in response to input data such as prompt sentences.
The term “outfit proposal information” refers to output information produced by the generative AI model in response to a prompt sentence, the output information describing one or more recommended outfits, including item types, relationships, and style indications.
The term “structured data” refers to data organized according to a predetermined schema, such as a set of fields or a hierarchical format, that includes at least component-wise item information, color attribute information, style attribute information, and emotion correspondence attribute information derived from outfit proposal information.
The term “component-wise item information” refers to structured data specifying individual elements of an outfit, including item categories such as tops, bottoms, outerwear, footwear, and accessories, and their associated attributes.
The term “style attribute information” refers to structured data indicating stylistic characteristics of an outfit, such as casual, formal, sporty, elegant, or similar style descriptors.
The term “emotion correspondence attribute information” refers to structured data representing a relationship between an outfit or clothing component and an emotion state, such as a designation that an outfit is suitable for a joyful mood or for uplifting a down mood.
The term “visual display data” refers to data used to generate a two-dimensional graphical representation of outfits or clothing items on a display device of an information processing terminal.
The term “three-dimensional display data” refers to data used to generate a three-dimensional or depth-aware graphical representation, including model geometry, texture data, and pose parameters, for presenting outfits or clothing items.
The term “evaluation information” refers to data indicating a user's assessment of an outfit proposal, including explicit inputs such as likes, dislikes, ratings, or textual comments.
The term “operation history information” refers to data representing a record of user operations within the system, such as selections, navigation actions, repeated requests, or confirmations, which can be used to infer user preferences.
The term “instruction content” refers to a logical specification of operations requested from a generative AI model, including constraints, goals, and contextual information encoded in a prompt sentence.
The term “personalize the outfit proposal information” refers to adjusting generated outfit recommendations in accordance with information specific to an individual user, including user attributes, preferences, emotion states, and past interactions.
The term “virtual display control information” refers to data that defines how components of an outfit are to be applied, positioned, and rendered on a body model or substitute representation body in a virtual environment.
The term “body model” refers to a digital representation of a human body, including one or more geometric meshes or skeleton structures, used to virtually apply and display clothing in three dimensions.
The term “substitute representation body” refers to a non-user-specific avatar, mannequin, or other representation used as a stand-in for a user's body for the purpose of virtually displaying outfits.
The term “virtual try-on format” refers to a display mode in which outfits are virtually applied to a body model or substitute representation body and presented to a user as if the user were wearing the outfits.
The term “augmented reality display” refers to a display technique in which digital images, including outfits or clothing items, are overlaid on or combined with a view of a real-world scene captured by a camera.
The term “three-dimensional display” refers to a display technique that presents content with depth perception or spatial positioning, such as stereoscopic display, rendered 3D models, or interactive 3D scenes, for viewing outfits or clothing items.

The following embodiments describe concrete examples of how the claimed invention may be implemented. These embodiments are provided to enable a person skilled in the art to make and use the invention and to illustrate ways in which the invention improves the functioning of computer systems, rather than to limit the scope of the claims.

Server, terminal, and user cooperate to implement a coordinated outfit recommendation and virtual try-on system that utilizes a generative AI model controlled by a prompt sentence generated from multi-modal data, including clothing image features, reference outfit features, user conditions, and user emotion.

### 1. System Architecture

Server includes at least one processor, a volatile storage unit, a non-volatile storage unit, and a communication interface connected to a communication network. Server executes an operating system and one or more application programs that implement image processing, feature extraction, similarity computation, prompt sentence generation, generative AI interaction, structured parsing, and rendering data generation.

Terminal includes at least one processor, a camera sensor, an optional depth sensor, a display device (for example, a flat panel display or an optical display in a head-mounted device), and a communication interface. Terminal executes an operating system and a dedicated application that handles user interaction, image capture, transmission of data to server, and rendering of received recommendations, optionally including three-dimensional or augmented reality visualization using a three-dimensional rendering engine.

User operates terminal to capture clothing images, input conditions and emotions, and view or evaluate recommended outfits.

### 2. Clothing Image Acquisition and Preprocessing

User uses terminal to capture images of clothing items. Terminal controls the camera sensor to acquire raw image data, typically in a standard color format. Terminal converts the raw sensor data to a compressed digital image format such as JPEG or PNG and stores it in a local file system or memory.

Terminal transmits the digital image files to server via the communication interface using a secure transport protocol. Terminal may also attach metadata such as a device identifier, a user identifier, and capture parameters (for example, resolution, capture time).

Server receives the digital image files and stores them in a non-volatile storage unit. Server loads each image into a memory buffer and applies pixel-level preprocessing using an image processing library such as OpenCV. In one embodiment, server resizes each image to a fixed resolution, converts the color space to a normalized representation, applies noise reduction filters, and optionally performs background removal or clothing region segmentation using contour detection or semantic segmentation techniques.

Server then performs feature extraction using a convolutional neural network. In one embodiment, server uses a residual network architecture having multiple convolutional layers, batch normalization layers, activation layers (for example, rectified linear units), and skip connections. Server truncates the network at an intermediate layer and uses the activation values at that layer as a high-dimensional feature vector that encodes clothing color, shape, pattern, and category attributes.

Server normalizes each feature vector by applying at least one of mean normalization, variance normalization, or L2 normalization, thereby enabling stable similarity calculations and reducing the effect of scale differences. Server stores the normalized feature vectors in association with clothing image identifiers in the storage unit.

This specific combination of pixel-level preprocessing with a deep neural network feature extractor improves technical performance by reducing noise and background artifacts before high-level feature computation, thereby decreasing erroneous similarity matches and reducing computational load in downstream processing.

### 3. Reference Outfit Database and Similarity Computation

Server maintains a reference outfit database populated with images and metadata collected from external information sharing platforms or internal sources. Server periodically retrieves outfit images and associated textual tags via an application programming interface or by batch import.

Server applies the same preprocessing and feature extraction pipeline to each reference image as described above, thereby ensuring that user clothing features and reference outfit features reside in a common feature space. Server stores reference feature vectors together with metadata such as style tags, season tags, user demographic tags, and item category lists.

Server constructs a vector index structure, such as an approximate nearest neighbor index, that supports efficient similarity queries in high-dimensional space. In one embodiment, server uses a clustering-based or tree-based approximate nearest neighbor algorithm to reduce similarity computation time compared to brute-force pairwise comparisons.

Server calculates similarity between a user clothing feature vector and each candidate reference outfit feature vector using a similarity function, such as cosine similarity or Euclidean distance. Server selects top-ranked reference outfits as outfit candidates. This similarity-based selection is a technical process that leverages numeric feature representations and optimized indexing structures to reduce latency and improve recall of relevant combinations, rather than simply matching symbolic tags.

### 4. Condition and Emotion Acquisition

User specifies conditions through terminal. User may input an age range, a style preference (such as casual, formal, or sporty), a use scene (such as date, office, or party), and a season (such as spring or winter). Terminal converts these inputs into a structured representation, for example, by mapping text choices into enumerated codes or key-value pairs, and transmits the structured condition data to server.

User optionally provides an emotion indication. User may select an emotion from a list displayed on terminal, or user may allow automatic emotion estimation based on facial expression or voice tone. In the latter case, terminal acquires facial images from the front camera or audio samples from a microphone and transmits them to server or to an external computation resource.

Server or the external computation resource executes an emotion recognition algorithm. In one embodiment, a convolutional neural network trained on labeled facial expression datasets is used to classify image regions into emotion categories, with a softmax layer computing probability values for each category. In another embodiment, a recurrent neural network or transformer-based model is used for voice emotion classification. The emotion classification model is trained by optimizing a loss function such as cross-entropy between predicted probabilities and ground-truth labels, using stochastic gradient descent or a variant thereof. During training, data augmentation techniques such as random cropping, brightness adjustment, or noise addition may be used to improve robustness and reduce overfitting.

Server receives an emotion label and associated confidence values and stores them as emotion state information linked to the user session or request.

By integrating emotion recognition into the same computational pipeline that processes image features and conditions, server can optimize network usage and processing schedules, for example by batching inference requests or sharing intermediate results between models, which improves throughput and reduces overall computational overhead.

### 5. Prompt Sentence Generation for the Generative AI Model

Server generates a prompt sentence that encodes clothing features, outfit candidate information, user conditions, and emotion state information in natural language. Server uses a predefined template system or rule-based text assembly procedure implemented as a module.

Server converts numeric feature vectors into descriptive attributes by mapping feature dimensions to interpretable labels learned from training data or manually defined mapping tables. For example, server may infer that a feature vector corresponds to “blue long-sleeve shirt” or “black slim-fit jeans” based on classification layers trained on category and color labels.

Server retrieves metadata from top-ranked outfit candidates, such as tags indicating “spring casual”, “20s”, or “date style”, and transforms them into descriptive phrases.

Server then assembles a prompt sentence that includes: (i) a role definition for the generative AI model, (ii) a description of user-owned clothing, (iii) user conditions, (iv) emotion state, and (v) explicit constraints or desired output structure. Examples of such prompt sentences include:
“You are a fashion stylist. Using the user's blue denim jacket and white T-shirt, please propose a casual spring outfit for a 25-year-old male. The user feels joyful, so please prioritize bright and cheerful colors.”
“Based on the user's red dress and black heels, please propose a unique and surprising outfit for a spring party. The user's emotion is ‘surprise’, so make the coordination playful and eye-catching.”
“User is in their 20s and in a fun mood. Please propose a casual outfit that uses a blue shirt and light jeans and matches a bright, playful spring atmosphere.”
“User is feeling down and wants an uplifting outfit for a casual weekend. Please use the user's gray hoodie and sneakers and add items that make the coordination feel light and positive.”

Server constructs the prompt sentence by concatenating these elements and may apply a set of heuristic rules or non-conventional ordering strategies designed to emphasize numerical features and similarity-based context, rather than only simple textual user preferences. This structured prompt generation improves the quality and relevance of generative outputs and reduces the need for multiple correction cycles, thereby reducing network traffic and processing time for repeated generative calls.

### 6. Generative AI Model Interaction and Structured Parsing

Server transmits the prompt sentence to a generative AI model hosted either locally or as a remote service. The generative AI model is generally implemented as a transformer-based neural network with multiple self-attention layers, feed-forward layers, and layer normalization components. The model is trained using a large corpus of text and, optionally, multimodal data, by minimizing a prediction loss function over next-token probabilities using gradient-based optimization.

Server configures the generative AI model's parameters for a particular request, such as temperature, maximum token length, and decoding strategy. These parameters influence generation diversity and determinism and can be tuned to optimize user experience and processing cost.

Server receives natural language text as output describing one or more outfits. Server applies a deterministic parsing module to transform the unstructured text into structured data. This module uses pattern-based rules, tokenization, and category lexicons to identify item types (tops, bottoms, outerwear, footwear, accessories), colors, materials, and style descriptors. Server may also use a lightweight classification model that detects style tags (for example, casual or formal) and emotion alignment (for example, uplifting, calm).

Server resolves ambiguous items by matching parsed descriptions with metadata in the database. For example, if the generative AI model recommends “white sneakers”, server searches the user's wardrobe data and, if not present, an associated product database for entries that best match the combination of item type and color.

By converting free-form generative outputs into machine-interpretable structured records, server enables downstream modules to operate on reliable structured data. This reduces manual intervention and avoids fragile string-based heuristics that could increase error rates and maintenance complexity. The structured parsing step therefore improves the technical robustness and scalability of the recommendation pipeline.

### 7. Rendering Data Generation and Virtual Try-On

Server generates visual display data and, when supported, three-dimensional display data based on the structured outfit proposal. Server selects image resources of user clothing and corresponding reference images of recommended items. Server assembles layout data for two-dimensional rendering, such as arrangement positions and display sizes, and packs this information together with textual descriptions.

For three-dimensional visualization, server maps item types and attributes to generic three-dimensional clothing meshes, such as top meshes, bottom meshes, and footwear meshes, stored in a model repository. Server applies material parameters and color modifications derived from the parsed attributes to the associated meshes. Server also generates a configuration for a body model or substitute representation body, including skeleton parameters and size scaling based on user attribute information.

Server produces virtual display control information containing references to meshes, textures, transformation matrices, and camera parameters. Server transmits this control information, along with item-level metadata, to terminal.

Terminal executes a three-dimensional rendering engine to interpret the control information.

Terminal constructs a scene graph that includes an avatar node, clothing mesh nodes, and a camera node. Terminal binds the clothing meshes to the body model and applies the transformation matrices to align clothing with the avatar. Terminal renders the scene from one or more viewing angles and presents the result on the display device. In the case of augmented reality display, terminal overlays the rendered clothing on a live video stream from the camera, tracking the user's body or a reference object to maintain alignment.

This coupling between structured generative output, virtual display control information, and three-dimensional rendering achieves a technical effect beyond simple textual recommendation. The system enables real-time virtual try-on with reduced latency and improved visual coherence because the clothing layout and attributes are computed and encoded at the server using a consistent representation.

### 8. Feedback Loop and Adaptive Prompt Refinement

User evaluates the displayed outfits using terminal. User may select options such as “like”, “dislike”, “more colorful”, or “simpler look”. Terminal records these actions as evaluation information and operation history information. Terminal transmits such information to server.

Server aggregates user feedback as structured preference records. Server may compute statistics, such as the proportion of liked outfits containing certain style attributes, or a distribution of colors for accepted outfits. Server stores these statistics as user-specific preference vectors.

Server modifies subsequent prompt sentences by adding clauses reflecting learned preferences, for example:
“Based on the user's previous likes (prefers simple and clean styles and light colors), please propose a new spring casual outfit using the user's blue shirt and white sneakers. The user's current mood is joyful.”

Server may also adjust parameters of the generative AI call, such as lowering temperature to reduce variability when user consistently prefers minimal changes, or increasing the weight of certain style descriptions in the prompt sentence. Additionally, server may refine similarity computations by increasing the weight given to feature dimensions corresponding to color or style attributes that correlate with user satisfaction.

These adaptive behaviors are implemented as algorithmic modifications at the data and model interface level and are not limited to simply repeating human decision rules. By formalizing feedback into numeric preference vectors and incorporating them into both similarity weighting and prompt construction, server reduces the need for repeated trial prompts and improves convergence to user-preferred solutions, which reduces unnecessary model invocations and network transfers.

### 9. Technical Effects and Computer Technology Improvement

The described system improves the functioning of computer technology in several ways.
First, server transforms high-dimensional image data into normalized feature vectors and performs similarity searching using efficient index structures. This arrangement reduces the number of generative AI calls required to produce relevant outputs because server can pre-filter candidate outfits based on numeric similarity rather than relying solely on user-provided tags or free-form textual prompts. This reduces processing time and network load.
Second, server constructs a prompt sentence by combining multi-modal structured data (numerical features, metadata, emotion states, user preferences) in a non-conventional way. Instead of simply translating user desires into text, server programmatically encodes calculated similarities and inferred attributes into the prompt sentence. This leads to higher-quality generative outputs and fewer corrective interactions, improving overall throughput.
Third, server systematically parses generative outputs into structured data that drive downstream rendering and selection algorithms. This structured conversion reduces parsing errors, allows efficient mapping to database entries, and supports deterministic generation of three-dimensional or augmented reality scenes. Because of this structure, client-side rendering can be optimized and decoupled from language processing, allowing independent improvements in rendering performance.
Fourth, server incorporates a feedback-driven adjustment mechanism at the prompting and similarity-computation stages. This closed-loop control uses objective measures such as evaluation rates and operation histories to modify numeric weights and text patterns. As a result, the system adapts more quickly to user preferences than systems that rely on fixed rule sets or manual configuration, which constitutes a technical improvement in recommendation engine behavior.
Fifth, the multiple neural network modules used in the system (clothing feature extractor, emotion classifier, generative AI model) are integrated with specific training strategies, including use of supervised learning, loss function optimization, and data augmentation. These networks operate on numeric data structures and model parameters that are updated during training and then executed deterministically during inference. This specific integration and the use of trained models for image feature extraction and emotion classification produce accuracy improvements and reduce error rates in similarity matching and emotional alignment, thereby enhancing system reliability.

### 10. Alternative Embodiments and Variations

Server may use alternative neural network architectures for feature extraction, including densely connected networks, vision transformers, or compact networks suitable for edge deployment. Server may also offload part of the feature extraction to terminal when terminal has sufficient computational capacity, thereby further reducing communication bandwidth.

Server may implement different similarity metrics, such as learned metric embeddings where an additional neural network is trained to map features into a space where semantically similar clothing items are closer together. Such metric learning further improves relevance of selected outfit candidates and reduces false positives.

Server may support multiple generative AI models, switching between them based on resource availability or required output detail. For example, server may use a smaller model for fast, low-detail recommendations and a larger model for more sophisticated styling scenarios.

Terminal may be implemented as a head-mounted device providing continuous augmented reality overlay of recommended items, or as a tablet or desktop device providing large-screen three-dimensional visualization. Terminal may also implement local caching of visual resources and partial rendering pipelines to reduce latency.

User may interact with the system through different modalities, such as voice commands, gesture controls, or haptic feedback. Terminal converts such interactions into structured events that server uses as part of operation history information.

These variations maintain the essential technical principle of the invention: server receives multi-modal input, performs image and emotion analysis, computes similarity, generates a prompt sentence controlling a generative AI model, converts generative output to structured data, and produces visual or virtual try-on representations, while adaptively refining the process based on user feedback.

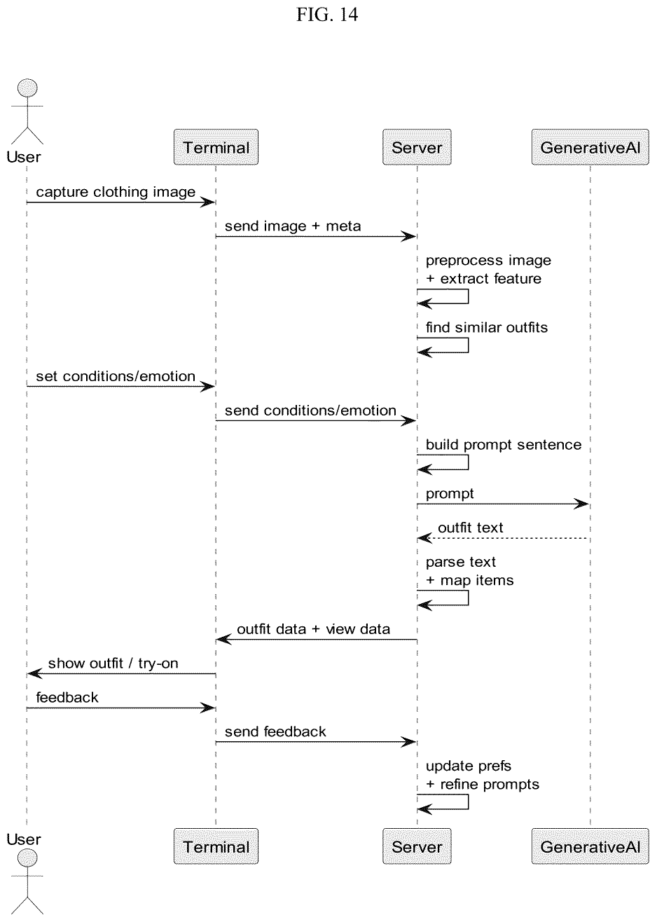

The following describes the processing flow using FIG. 14.

### Step 1:

User operates the terminal to capture one or more images of clothing.

User points the terminal's camera at a clothing item, adjusts framing, and triggers the capture control.
Input: real-world clothing item and camera sensor signals.
Output: digital image data (for example, a JPEG or PNG file) stored in the terminal's local storage.

### Step 2:

Terminal prepares clothing image data and metadata for transmission.

Terminal retrieves the stored image file, attaches user identification, device identification, and optional capture parameters (time, resolution), and builds a request payload using a network protocol.
Input: local image file and user/session information.
Output: a structured transmission packet containing image data and metadata.

### Step 3:

Terminal transmits the clothing image data to the server.

Terminal opens a secure communication channel to the server, sends the transmission packet, and waits for an acknowledgment.
Input: structured transmission packet containing image data and metadata.
Output: a network message delivered to the server and a confirmation status returned to the terminal.

### Step 4:

Server receives and stores the clothing image data.

Server validates the packet, checks file format and size, and writes the image data to non-volatile storage while registering a unique image identifier in a database.
Input: network message containing image data and metadata.
Output: a stored image file reference and a registered image identifier associated with the user.

### Step 5:

Server performs pixel-level preprocessing on the clothing image.

Server loads the image into memory, resizes it to a predefined resolution, converts the color space, and applies noise reduction filters using an image processing library.
Input: stored image file reference.
Output: a preprocessed image matrix normalized for feature extraction.

### Step 6:

Server extracts numerical feature data representing the clothing.

Server applies a convolutional neural network to the preprocessed image, obtains activation values from a selected layer, and normalizes the resulting vector.
Input: preprocessed image matrix.
Output: a normalized feature vector encoding color, shape, pattern, and category attributes linked to the image identifier.

### Step 7:

Server retrieves and preprocesses reference outfit images.

Server loads reference images from a reference database or external platform, applies the same resizing, color conversion, and filtering procedures, and prepares them for feature extraction.
Input: references to multiple outfit images and associated metadata.
Output: a set of preprocessed reference image matrices.

### Step 8:

Server generates feature vectors for reference outfits and builds a similarity index.

Server passes each preprocessed reference image through the convolutional neural network, normalizes each resulting feature vector, and inserts the vectors into an index structure optimized for similarity search.
Input: preprocessed reference image matrices.
Output: a feature index of normalized reference outfit vectors associated with outfit identifiers and metadata.

### Step 9:

User specifies outfit conditions and optionally an emotion state on the terminal.

User selects or inputs attributes such as age, season, style, and use scene, and may also choose or indicate a current mood.
Input: user's preferences expressed as selections, text, or voice input.
Output: structured condition information and optional raw emotion-related data stored in the terminal's memory.

### Step 10:

Terminal converts user conditions and emotion indications into structured data and sends them to the server.

Terminal maps user selections to codes or key-value pairs, converts voice input to text if needed, and packages the condition and emotion indications into a request message.
Input: condition information and optional raw emotion-related data.
Output: a structured condition and emotion packet transmitted to the server.

### Step 11:

Server determines the user's emotion state.

Server either parses explicit emotion labels from the condition packet or processes raw facial/voice data using an emotion classification model to produce an emotion category and confidence score.
Input: structured condition and emotion packet, including optional image or audio samples.
Output: an emotion state record consisting of an emotion label and associated confidence values.

### Step 12:

Server selects relevant user clothing and computes similarity to reference outfits.

Server retrieves the user's clothing feature vectors from the database, queries the reference feature index using similarity metrics, and ranks reference outfits by distance or similarity score.
Input: user clothing feature vectors and reference feature index.
Output: a ranked list of outfit candidates associated with similarity scores and metadata.

### Step 13:

Server derives descriptive attributes from feature vectors and metadata.

Server maps numeric features of user clothing and outfit candidates to human-readable labels such as color names, clothing categories, and style descriptors using classification layers or lookup tables.
Input: clothing feature vectors and associated metadata.
Output: descriptive attribute sets for user clothing and outfit candidates.

### Step 14:

Server constructs a prompt sentence for the generative AI model.

Server combines user condition information, emotion state, descriptive attributes of user clothing, and tags from similar outfits into a natural-language instruction string.
Input: condition information, emotion state record, and descriptive attribute sets.
Output: a prompt sentence that defines the generation task for the generative AI model.

### Step 15:

Server sends the prompt sentence to the generative AI model and obtains textual outfit proposals.

Server calls the generative AI model with the prompt sentence, waits for completion, and receives generated text that describes one or more recommended outfits.
Input: prompt sentence.
Output: natural-language outfit proposal text returned by the generative AI model.

### Step 16:

Server parses the outfit proposal text into structured data.

Server tokenizes the generated text, detects item categories, colors, and style terms using rules and dictionaries, and builds a structured record describing each proposed outfit component.
Input: outfit proposal text.
Output: structured outfit proposal data including component-wise item entries, color attributes, style attributes, and emotion correspondence attributes.

### Step 17:

Server maps proposed items to actual clothing resources.

Server matches each structured item entry to either user-owned clothing entries or reference or catalog entries, using type, color, and style attributes as matching criteria.
Input: structured outfit proposal data and database records of available items.
Output: an enriched structured outfit record linked to concrete image identifiers or resource identifiers.

### Step 18:

Server generates visual display data and optional three-dimensional display data.

Server chooses appropriate images for each outfit component, arranges their display positions, and, when three-dimensional visualization is enabled, assigns corresponding meshes and material parameters to each item.
Input: enriched structured outfit record with item identifiers.
Output: visual layout data and virtual display control data describing how items should be presented.

### Step 19:

Server transmits the structured proposal and display data to the terminal.

Server packages the structured outfit record, visual layout parameters, and virtual display control data into a response message and sends it to the terminal.
Input: visual layout data and virtual display control data.
Output: a recommendation response delivered to the terminal containing both semantic and rendering information.

### Step 20:

Terminal renders the outfit proposal on the display device.

Terminal decodes the response, loads the associated images, arranges them according to layout parameters, and, if three-dimensional or augmented reality display is enabled, instantiates a scene with an avatar and clothing meshes, rendering the result for user viewing.
Input: recommendation response with structured proposal and display data.
Output: a visual presentation of the recommended outfit on the terminal's display, optionally including a virtual try-on representation.

### Step 21:

User evaluates the proposed outfit and optionally modifies conditions.

User interacts with buttons or gestures to indicate preferences, such as accepting, rejecting, or requesting alternatives, and may adjust style, season, or other conditions.
Input: visual presentation of the recommended outfit.
Output: user feedback actions and updated condition selections stored in the terminal.

### Step 22:

Terminal sends feedback and updated conditions to the server.

Terminal collects user feedback and modified conditions, converts them into structured fields, and transmits them as an update packet to the server.
Input: user feedback actions and updated condition selections.
Output: a feedback and condition update message delivered to the server.

### Step 23:

Server updates user preference data and refines future prompt sentences.

Server incorporates feedback into a preference profile by updating statistics or preference weights and adjusts future prompt construction rules and similarity weights accordingly.
Input: feedback and condition update message and existing user preference profile.
Output: an updated user preference profile and revised prompt generation parameters for subsequent interactions.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

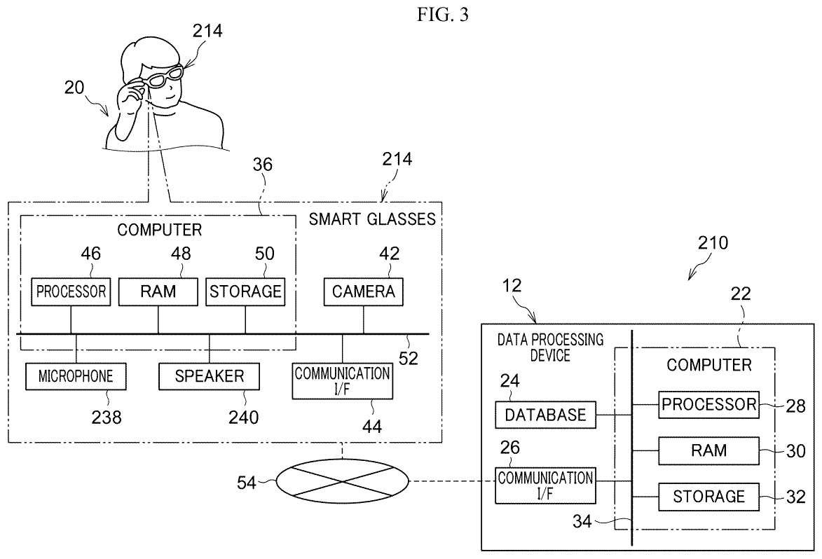

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

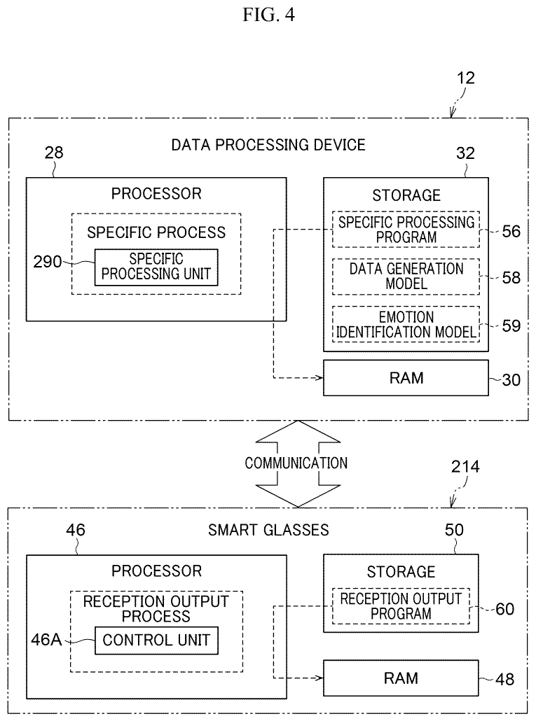

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

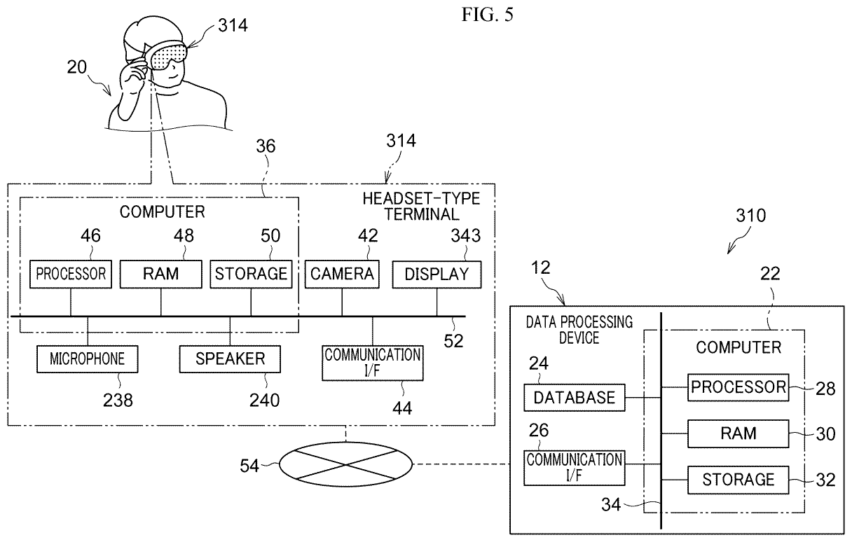

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

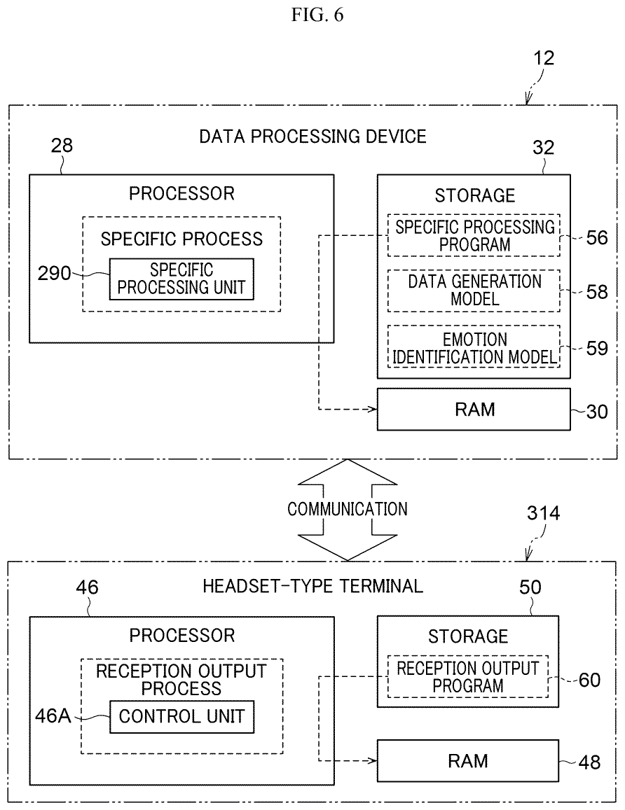

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

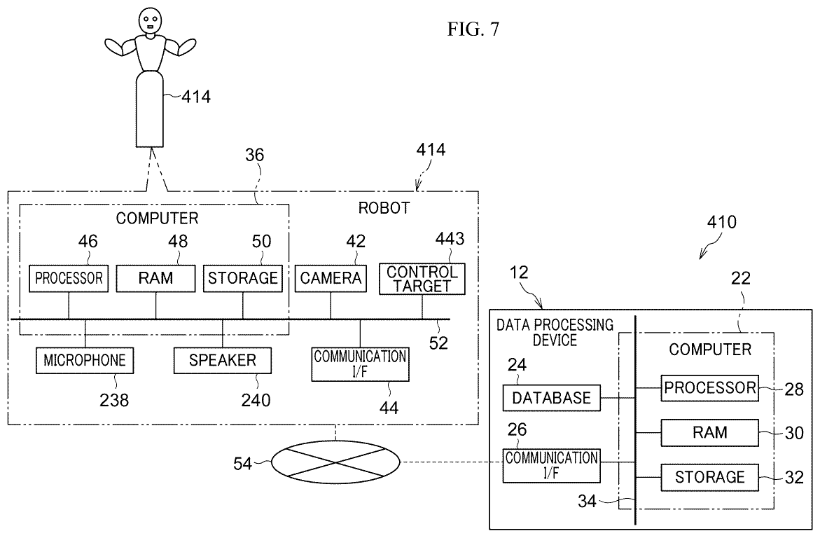

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

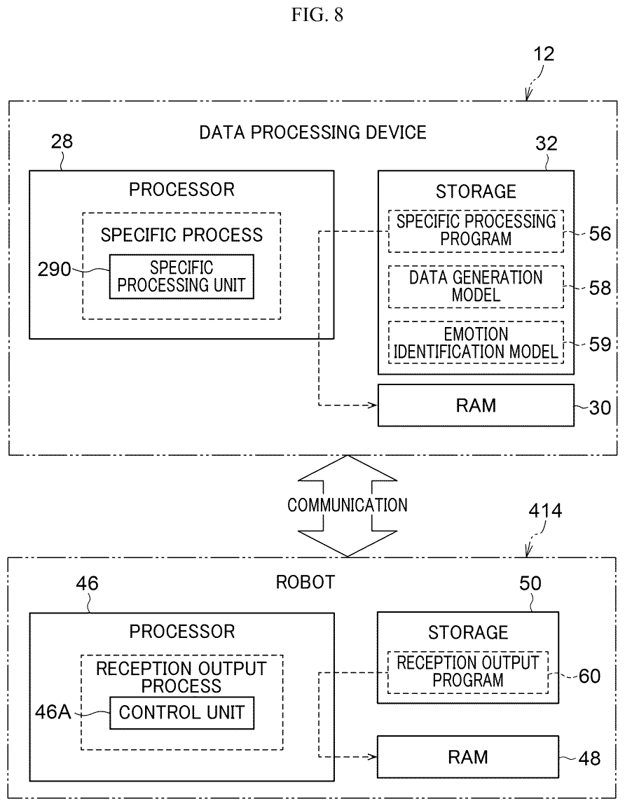

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

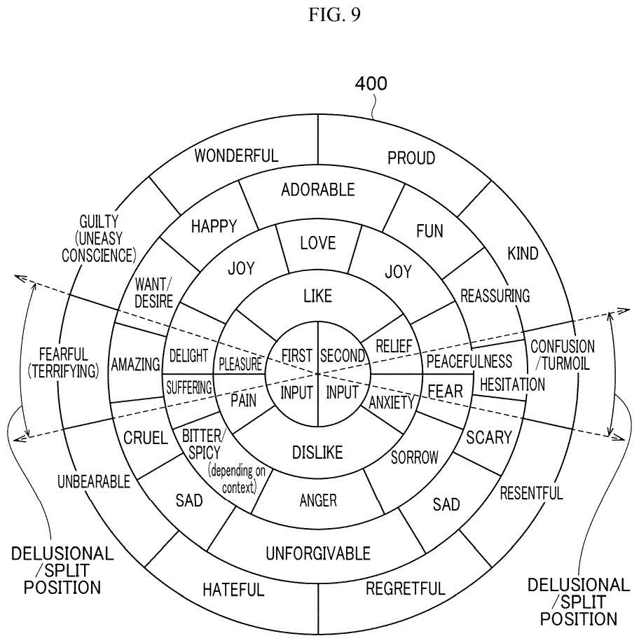

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

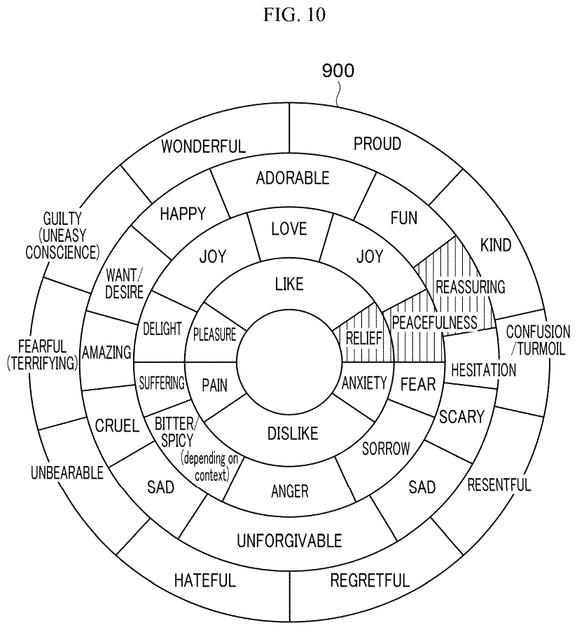

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
obtain, via a terminal device, image data of an article possessed by a user and receive the image data from the terminal device through a communication procedure,
preprocess the image data by using an image processing algorithm so as to convert the image data into an input format of a machine learning model and extract feature information representing attributes of the article from the image data,
calculate, on the basis of the extracted feature information, a similarity between the feature information and reference data stored in a storage device or an external information providing device as an information source, and rank candidate proposal information according to the similarity,
convert context information including the feature information and the candidate proposal information into text data, generate a prompt sentence including the text data, and generate request data for inputting the prompt sentence to a generative AI model that performs natural language generation processing,
obtain natural language descriptions regarding the candidate proposal information, the natural language descriptions being output from the generative AI model, associate the natural language descriptions with the candidate proposal information to generate proposal result data, and transmit the proposal result data to the terminal device, and
cause the terminal device to analyze the proposal result data and control display of the candidate proposal information and the natural language descriptions.

### Supplementary 2

The system according to supplementary 1,
wherein the processor is configured to
acquire usage condition information input by the user via the terminal device, include the usage condition information in the context information so as to adjust the prompt sentence, and cause the generative AI model to generate proposals in consideration of the usage condition information.

### Supplementary 3

The system according to supplementary 1,
wherein the processor is configured to
analyze contents of a plurality of natural language descriptions output from the generative AI model, reevaluate the candidate proposal information based on a ranking result of the similarity and the contents of the natural language descriptions, and configure the proposal result data according to a ranking result after the reevaluation.

### Application Example 1

### Supplementary 1

A system comprising a processor,
wherein the processor is configured to
acquire, from an information processing terminal operated by a user, image data corresponding to clothing possessed by the user,
analyze the image data by executing image recognition processing to extract feature information of the clothing including at least color, shape, pattern, material, and category, and to generate a numerical vector representing the feature information,
calculate similarity, by using the numerical vector, with respect to a group of outfit image data acquired from an information providing service in which outfit image data is stored, and extract outfit image data having high similarity from the group of outfit image data,
generate a prompt sentence including an instruction to a generative model to generate outfit candidates using the clothing, based on the feature information and the outfit image data having high similarity,
input the prompt sentence into the generative model to obtain outfit proposal information including a plurality of outfit proposals each including the clothing,
assign three-dimensional shape data to clothing elements included in the outfit proposal information and generate three-dimensional clothing models adapted to body shape data associated with the user, and
transmit the three-dimensional clothing models to the information processing terminal and output display control information enabling execution of a try-on simulation of the clothing in a virtual space on the information processing terminal.

### Supplementary 2

The system according to supplementary 1,
wherein the processor is configured to acquire condition information including at least preference information, usage scene information, season information, body shape information, and budget information input by the user, and to adjust the prompt sentence by changing instruction content to the generative model based on a combination of the condition information, the feature information, and the outfit image data having high similarity.

### Supplementary 3

The system according to supplementary 1,
wherein the processor is configured to acquire evaluation information from the user regarding the outfit proposal information, and to update components of the prompt sentence and parameters used for the similarity calculation based on the evaluation information so as to sequentially and adaptively change instruction content to the generative model to generate outfit proposal information optimized for each user.

### Example 2

### Supplementary 1

A system comprising a processor,
wherein the processor is configured to
acquire, from a terminal operated by a user, clothing images representing clothing items possessed by the user and condition information including attributes and a situation of the user,
analyze the acquired clothing images by using an image processing apparatus and a trained image recognition model to extract feature amounts representing at least a color, a shape, a pattern, and a category of each clothing item,
generate a prompt sentence including search instruction content for acquiring outfit image data from an information sharing service, on the basis of the condition information including the attributes and the situation of the user and the feature amounts of the clothing items, and input the prompt sentence to a generative AI model to acquire search terms and identification information for the information sharing service,
acquire, from the information sharing service, outfit image data and associated information on the basis of the search terms and the identification information acquired from the generative AI model,
analyze the acquired outfit image data by using the trained image recognition model to extract feature amounts belonging to a same feature space as the feature amounts of the clothing items possessed by the user,
calculate similarity between the feature amounts of the clothing items possessed by the user and the feature amounts of the outfit image data, and select outfit candidates to be proposed to the user on the basis of the similarity and the condition information, and
output, to the terminal, combination information of clothing items corresponding to the selected outfit candidates and the outfit image data corresponding to the selected outfit candidates.

### Supplementary 2

The system according to supplementary 1,
wherein the processor is configured to
dynamically generate the prompt sentence on the basis of the condition information including the attributes and the situation of the user and information regarding categories and colors of the clothing items possessed by the user, and adjust the search terms and the identification information acquired from the generative AI model so that the search terms and the identification information are consistent with the condition information and the feature amounts of the clothing items.

### Supplementary 3

The system according to supplementary 1,
wherein the processor is configured to
rank the outfit candidates by integrating an evaluation value based on the similarity and a popularity index of the outfit image data in the information sharing service, and determine outfit candidates to be presented to the user via the terminal on the basis of a result of the ranking.

### Application Example 2

### Supplementary 1

A system comprising a processor,
wherein the processor is configured to
receive image information including clothing from an information processing terminal operated by a user, and perform pixel-level preprocessing and feature extraction on the image information to generate numerical feature data representing at least a color attribute, a shape attribute, a pattern attribute, and a category attribute of the clothing,
generate numerical feature data of the same type for reference image information including outfits acquired from an external information sharing platform, and select one or more outfit candidates similar to the clothing by calculating similarity between the numerical feature data of the clothing and the numerical feature data of the reference image information,
acquire condition information including at least a user attribute, a use scene, and a season from the information processing terminal, and acquire emotion state information of the user estimated by the information processing terminal or by an external computation resource, and
generate a prompt sentence described in natural language, the prompt sentence defining processing content to cause a generative AI model to generate an outfit proposal or a decoration proposal, based on the condition information, the emotion state information, the outfit candidates, and the numerical feature data of the clothing,
input the prompt sentence to the generative AI model, acquire outfit proposal information output from the generative AI model, and convert the outfit proposal information into structured data including at least component-wise item information, color attribute information, style attribute information, and emotion correspondence attribute information, and
generate visual display data or three-dimensional display data associated with the image information of the clothing and the outfit candidates, based on the outfit proposal information included in the structured data, and transmit the outfit proposal information and the visual display data to the information processing terminal.

### Supplementary 2

The system according to supplementary 1,
wherein the processor is configured to acquire evaluation information or operation history information from the information processing terminal, the evaluation information or the operation history information being based on a user operation, and update at least one of the condition information and an expression content included in the prompt sentence based on the evaluation information or the operation history information, thereby sequentially adjusting an instruction content to the generative AI model to personalize the outfit proposal information for the user.

### Supplementary 3

The system according to supplementary 1,
wherein the processor is configured to generate virtual display control information, based on the structured data, for virtually applying components included in the outfit proposal
information to a body model of the user or to a substitute representation body, and cause the information processing terminal to present the outfit proposal information in a virtual try-on format as augmented reality display or three-dimensional display.

What is claimed is:

1. A system comprising:
circuitry configured to:
receive, via a communication interface coupled to a packet-switched network, image data of an item from a terminal device;
analyze the received image data to extract feature information of the item including at least a color attribute, a shape attribute, and a pattern attribute;
generate a token sequence for instructing a trained neural network model to perform a similarity computation based on the extracted feature information; and
transmit, via the communication interface, result data of the similarity computation to the terminal device.

2. The system according to claim 1, wherein the circuitry analyzes the received image data by applying a convolutional neural network comprising a plurality of convolutional layers and a plurality of pooling layers to generate a multidimensional feature vector representing the feature information.

3. The system according to claim 2, wherein the circuitry normalizes the multidimensional feature vector by applying L2 normalization to produce a unit-length feature vector for use in the similarity computation.

4. The system according to claim 3, wherein the circuitry performs the similarity computation by calculating at least one of a cosine similarity or a Euclidean distance between the unit-length feature vector and a plurality of reference feature vectors stored in a storage device coupled to the packet-switched network.

5. The system according to claim 4, wherein the circuitry retrieves the plurality of reference feature vectors from an approximate nearest neighbor index stored in the storage device, the approximate nearest neighbor index being constructed from a corpus of reference image data.

6. The system according to claim 5, wherein the circuitry ranks results of the similarity computation to generate a ranked list of candidate items and transmits the ranked list to the terminal device via the communication interface.

7. The system according to claim 1, wherein the circuitry is further configured to receive context information from the terminal device and to construct the token sequence by combining the extracted feature information with the context information into a structured prompt data format.

8. The system according to claim 7, wherein the circuitry transmits the token sequence to the trained neural network model comprising a transformer architecture with a plurality of self-attention layers, and receives, from the trained neural network model, generated text data comprising a natural language description associated with the result data.

9. The system according to claim 8, wherein the circuitry is further configured to compute a textual relevance score between the generated text data and the context information, and to reevaluate the result data based on a combination of the similarity computation and the textual relevance score.

10. The system according to claim 9, wherein the circuitry is further configured to generate an updated token sequence incorporating the reevaluated result data and to transmit the updated token sequence to the trained neural network model to obtain refined generated text data.

11. The system according to claim 10, wherein the context information comprises at least one of user attribute data, situational data, or preference history data received from the terminal device.

12. The system according to claim 1, wherein the circuitry is further configured to generate three-dimensional shape data based on the extracted feature information by assigning geometric parameters to components of the item, and to generate virtual display control information for rendering the three-dimensional shape data on a display of the terminal device.

13. The system according to claim 12, wherein the circuitry is further configured to adapt the three-dimensional shape data to a body model of a user by adjusting the geometric parameters based on body measurement data received from the terminal device.

14. The system according to claim 13, wherein the circuitry is further configured to receive evaluation feedback data from the terminal device indicating a user assessment of the rendered three-dimensional shape data, and to update the geometric parameters based on the evaluation feedback data.

15. The system according to claim 14, wherein the item comprises a clothing article, and the circuitry generates the three-dimensional shape data by assigning geometric parameters to at least a body portion, a sleeve portion, and a collar portion of the clothing article.

16. The system according to claim 1, wherein the circuitry is further configured to generate search term data based on the extracted feature information and to transmit the search term data to an external information processing apparatus via the communication interface to retrieve external image data associated with the search term data.

17. The system according to claim 16, wherein the circuitry is further configured to extract external feature vectors from the retrieved external image data using the convolutional neural network, to compute a cross-dataset similarity between the multidimensional feature vector and the external feature vectors, and to integrate a popularity index associated with the external image data into the result data.

18. A system comprising:
circuitry configured to:
receive, via a communication interface coupled to a packet-switched network, image data of an item from a terminal device;
apply a convolutional neural network comprising a plurality of convolutional layers to the image data to extract a multidimensional feature vector, and normalize the multidimensional feature vector by L2 normalization to produce a unit-length feature vector;
retrieve, from an approximate nearest neighbor index stored in a storage device coupled to the packet-switched network, a set of reference feature vectors, and compute a similarity score between the unit-length feature vector and each reference feature vector using at least one of cosine similarity or Euclidean distance;
receive context information from the terminal device and construct a token sequence by combining the unit-length feature vector with the context information into a structured prompt data format;
transmit the token sequence to a trained neural network model comprising a transformer architecture with a plurality of self-attention layers and receive generated text data; and
compute a textual relevance score between the generated text data and the context information, reevaluate the similarity score based on a combination of the similarity score and the textual relevance score, and transmit result data to the terminal device via the communication interface.

19. The system according to claim 18, wherein the circuitry is further configured to generate three-dimensional shape data based on the extracted multidimensional feature vector and to adapt the three-dimensional shape data to a body model of a user based on body measurement data received from the terminal device.

20. A method comprising:
receiving, via a communication interface coupled to a packet-switched network, image data of an item from a terminal device;
analyzing the received image data to extract feature information of the item including at least a color attribute, a shape attribute, and a pattern attribute;
generating a token sequence for instructing a trained neural network model to perform a similarity computation based on the extracted feature information; and
transmitting, via the communication interface, result data of the similarity computation to the terminal device.
